(19) United States
(12) Patent Application Publication
(10) Pub. No.: US 2009/0094353 A1
(43) Pub. Date: Apr. 9, 2009

(54) INFORMATION PROCESSING APPARATUS AND INFORMATION PROCESSING SYSTEM

(75) Inventor: Takashi Isobe, Machida (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(73) Assignee: Hitachi, Ltd

(21) Appl. No.: 12/244,310

(22) Filed: Oct. 2, 2008

(30) Foreign Application Priority Data
Oct. 5, 2007 (JP) 2007-262249

(51) Int. Cl. G06F 15/177

(52) U.S. Cl. 709/221

(57) ABSTRACT

It is an object of the present invention to provide an information processing apparatus equipped with a many-core processor providing a VOD service having a fast playing response speed with a small size and power saving and an information processing system. In the information processing apparatus equipped with a many-core processor configuring an operation matrix that performs a reconfiguration for each packet based on a communication state, the functions and wirings of the operation matrix are reconfigured so that data is transmitted in a wideband transmission process when a transmitted data amount is smaller than a preset threshold value and the data is transmitted in a narrowband transmission process when the transmitted data amount is larger than the threshold value by comparing the transmitted data amount obtained by counting a transmission data amount of a transmission byte counter with the threshold value in a transmission amount/time determining unit and changing a communication state in a wideband/narrowband transmission state changing unit according to the comparison result.

### CLAIM OF PRIORITY

The present application claims priority from Japanese patent application JP 2007-262249 filed on Oct. 5, 2007, the content of which is hereby incorporated by reference into this application.

### BACKGROUND OF THE INVENTION

1. Field of the Invention

The present invention relates to a technology providing a server service, such as a video delivery, etc. by performing different processes according to communication states between terminals or hosts that are connected to a network to transmit and receive packets from and to the network so as to change data accumulated in an apparatus or a generation of new packets and transmit the newly generated packets to the outside.

2. Description of the Related Art

With the simultaneous development of a broadcast communication fusion and a ubiquitous, improving diversification and a sensory speed of services provided from a server are requested from both a back-end user and an access user. For this reason, apparatus distributing and arranging various server services (VOD (Video on Demand), query transaction of database, defense of abnormal communication, etc.) into an edge network require and an improvement of operation performance of the server service are needed.

Functions requested from the present apparatus device are different according to user, application, place, time, running state. Also, the apparatus having the above-mentioned functions should be distributed and arranged into the edge network so as to improve the efficiency of the operation performance, such as an apparatus as a small server or a board with a built-in communication apparatus. Therefore, a processor for the apparatus should be capable of performing a high-speed operation on packets through a small size and reducing power consumption while still maintaining general capability of performing various processes for each packet based on a communication state between terminals.

In connection with the capability of performing the high-speed operation on packets having a small size and reducing power consumption and general capability, a general-purpose processor or an Application Specific Integrated Circuit (ASIC) in the related art has a problem of achieving either of the capability of performing the high-speed operation on packets having a small size and reducing power consumption and general use thereof. The general-purpose processor can improve the operational performance by making plural processors into a cluster, but does not meet the requirements of consuming less power. On the other hand, the ASIC has the capability of performing a high-speed operation but does not meet the general use requirement.

In contrast, a dynamic reconfiguration processor (DRP), which is one of the many-core processors, includes an operation matrix that connects plural operation elements (Processing Element: PE) by a selector switch etc., and achieves high-speed operational performance at low power by parallelizing operations. Further, the operation function or the connection of PE is changed during the shortest clock, such that the high general use capable of changing the installation function in a short time is achieved. A high-speed operation that is performed while reducing power consumption is achieved by increasing parallel operations of the operation matrix core, such as executing simple instructions in a plural using plural operators, executing complex instructions using the plural combined operators, etc., without increasing the operation frequency. Therefore, the DRP is considered to be the next generation processor for apparatuses requiring both the capability of performing high-speed operation on the packets through a small size and reducing power consumption, including general use of an algorithm.

When the DRP is used in the apparatus providing the server service, an installation logic should be changed for each packet according to the communication state between the respective hosts transmitting and receiving packets (a transition/congestion state of a transport layer protocol, a kind of application layer protocol used, a kind of executed commands, a progress state of command under execution (where a file is transmitted and received), etc.) so as to realize the various processes for each packet. The change in the installation logic is started by the interruption for reconfiguration generated by a group of the operators in the operation matrix. Therefore, it is considered that the installation logic can be rapidly changed by previously generating information (the communication state between the respective hosts transmitting and receiving the received packets) necessary for generating the interruption for reconfiguration and directly inputting the information to the operation matrix.

As a result, the inventor designed an apparatus equipped with the dynamic reconfiguration processor by reconfiguring each packet based on the communication state between the terminals or the hosts (hereafter, generally referred to as a terminal)(“Query-Transaction Acceleration Appliance with a DRP using Stateful Packet-by-Packet Self-Reconfiguration”, Technical Report IEICE, Vol. 107, no. 41, RECONF2007-1, PP. 1-6, May, 2007). The apparatus directly inputs/outputs communication data without passing through a memory. Further, the installation logic can be rapidly changed and the server service of the application layer such as the database, etc. can be provided to have high performance while using a small size and power saving apparatus, by changing the installation logic of the operation matrix during the dynamic reconfiguration processor unit based on the communication state between the terminals previously generated during the outside of the operation matrix.

### BRIEF SUMMARY OF THE INVENTION

The above-mentioned technical problem of an apparatus equipped with a dynamic reconfiguration processor by reconfiguring each packet based on a communication state between terminals will be described with reference to FIGS. 24 and 25 by illustrating a case of providing a VOD service.

FIG. 24 shows the architecture of an apparatus equipped with a dynamic reconfiguration processor by reconfiguring each packet based on a communication state between terminals.

The apparatus includes a switch 2401 that switches packets, a dynamic reconfiguration processor (DRP) 2402 being a dynamic reconfiguration processing unit that performs various operations, a packet I/O 2400 that performs control of an input and an output of the packets between the switch 2401 and the DRP 2402, and an external memory 2403 that accumulates various data.

The packet I/O 2400 includes a classifier 2404 that classifies the packets received from the switch 2401, buffers 2405 and 2413 that temporarily accumulates the classified packets, a packet reading unit 2406 that reads the packets from the buffer 2405, a communication state table 2410 that accumulates the communication state, a communication state reading unit 2407 that reads the communication state, a communication state renewing unit 2408 that changes the communication state, a communication state writing unit 2409 that writes the communication state, a buffer 2411 that temporarily accumulates the changed communication state, a buffer 2412 that temporarily accumulates the read packets, and a concentrator 2414 that concentrates the packets.

A packet 2415 transmitted from the switch 2401 is classified into a packet 2417 on which a process should be performed and a packet 2418 on which a process should not be processed by the classifier 2404. The packet 2417 on which the process should be performed is accumulated in the buffer 2405.

The packet reading unit 2406 reads out the packets accumulated in the buffer 2405 (2419) and transmits the read packets to the communication state reading unit 2407, the communication state renewing unit 2408, and the buffer 2412 (2420).

The communication state reading unit 2407 reads a corresponding communication state 2422 from the communication state table 2410 based on transmission source/designation information writing the packet 2420 received from the packet reading unit 2406 and transmits (2448) the read communication state to the communication state renewing unit 2408.

The communication state renewing unit 2408 changes a communication state 2448 received from the communication state reading unit 2407 based on the packet 2420 received from the packet reading unit 2406. The changed communication states 2421 and 2449 are transmitted to the communication state writing unit 2409 and the buffer 2411.

The communication state writing unit 2409 writes as a new communication state 2423 the changed communication state 2421 received from the communication state renewing unit 2408 into the communication state table 2410.

The DRP 2402 includes a PE matrix 2427 with a built-in plural small operators, a general-purpose operator 2428, a configuration data cache 2430, an SDRAM I/F 2431 that is an interface for an external memory, and a bus switch 2429 coupling them.

PE matrix 2427 includes an interruption generation PE group for general-purpose reconfiguration 2434 that is reconfigured by the general-purpose operator, an interruption generation PE group for autonomous reconfiguration 2435 that is autonomously reconfigured by the PE matrix 2427, a PE group 2436 that performs various functions for the application, and a PE group 2437 that transmits a TCP/IP checksum operated packet and outputs operation end notification 2450 to the packet reading unit 2406.

The general-purpose operator 2428 operates an operating system (OS) 2432 and a function for reconfiguration 2433 that processes the reconfiguration.

When the interruption generation PE group for autonomous reconfiguration 2435 receives the changed communication state 2449 from the communication state renewing unit 2408, it generates an interruption for autonomous reconfiguration 2441 based on the received communication state 2449.

The configuration data cache 2430 (storage buffer) transmits the configuration data accumulated therein to the PE matrix 2427 based on the interruption for autonomous reconfiguration 2441 generated (2442).

The PE matrix 2427 reconfigures the function or the wiring of the internal operator based on the configuration data 2442 transmitted from the configuration data cache 2430.

When the interruption generation PE group for general-purpose reconfiguration 2434 receives the changed communication state 2449 from the communication state renewing unit 2408, it generates the interruption for general-purpose reconfiguration 2444 to the general-purpose operator 2428 based on the received communication state 2449. Further, a configuration data pointer 2438 in an external memory 2403 is rewritten into an address value where the configuration data scheduled to be used later based on the received communication state 2449 is accumulated (2443).

When the OS 2432 receives the interruption for general-purpose reconfiguration 2444 from the interruption generation PE group for general-purpose reconfiguration 2434, it is executed to call the function 2433 for reconfiguration.

The function 2433 for reconfiguration reads the address value where the configuration data to be used later is accumulated from the configuration data pointer 2438 (2446) and reads the configuration data scheduled to be used later from a configuration data area 2439 based on the read address value (2445). Also, the read configuration data is overwritten in the configuration data cache (2447). Further, the overwritten configuration data is transmitted to the PE matrix (2442).

The PE matrix 2427 reconfigures the function or the wiring of an internal operator based on the configuration data 2442 received from the configuration data cache 2430.

When the PE matrix 2427 completes the reconfiguration, it reads the communication state 2424 accumulated in the buffer 2411 and the packet 2425 accumulated in the buffer 2412 to be input to the PE group 2436 executing various functions for application.

The PE group 2436 executing the various functions for application performs various operations using the communication state 2424, the packet 2425, and the OS/application data area 2440 in the external memory 2403. Also, the changed communication state 2426 is transmitted to the communication state writing unit 2409. The communication state writing part 2409 writes the received communication state 2426 into communication state table 2410.

When the operation in the PE group 2436 executing the various functions for the application is completed, the PE group 2437 computes the TCP/IP checksum for newly generated packets and transmits the computed packet 2451 to a concentrator 2414 point by point. When all of the packets are transmitted, an operation end notification 2450 is transmitted to a packet reading unit 2406.

The concentrator 2414 concentrates the packets 2451 read from the PE matrix 2427 and the packets read from the buffer 2413 and outputs the read packets to the switch 2401 (2416).

When the packet reading unit 2406 receives the operation end notification 2450, it reads the new packets from the buffer 2405.

The apparatus equipped with the dynamic reconfiguration processor using the reconfiguration for each packet based on the communication state between the terminals is achieved by the above-mentioned method. The apparatus performs a parallel operation in the operation matrix by directly inputting/outputting communication data, which does not pass through the memory, making it possible to achieve a high-speed operation while using a small size and power saving apparatus. Also, the installation logic of the operation matrix in the dynamic reconfiguration processor is changed based on the communication state between the hosts that is previously generated outside of the operation matrix, making it possible to realize high-speed change in the installation logic and to realize various server services.

FIG. 25 is a schematic view of a case where a user 2505 receives a video delivery service from a VOD server 2500.

When the user 2505 receives the video delivery service from the VOD server 2500, he/she starts a video playing application 2502 to click a playing start instruction button 2503 with a mouse or to slide a playing point change slide 2504 with a mouse, thereby instructing the playing point and start of the video delivery to the VOD server 2500. The video data delivered by the VOD server 2500 is once accumulated in the playing buffer 2501 included in the video playing application 2502. After a sufficient amount of video data is accumulated in the playing buffer 2501, the video playing application 2502 starts the playing.

Therefore, there is a problem in that the time required to accumulate sufficient amount of video data in the playing buffer 2501 is long and the playing response speed until actual playing starts from the instruction of the change in the playing start and playing point is delayed.

In order to solve the problems, the present invention performs wideband transmission of the data in the receive buffer in a burst just after the server starts the playing instruction, making it possible to shorten a response time from the playing instruction to the playing start. Also, the present invention performs a normal narrowband transmission just after the wideband transmission of the data in the receive buffer is ended. In order to realize this, the communication state is changed according to whether the amount of transmission data exceeds the receive buffer and the logic circuit of the PE matrix is reconfigured of either of the wideband transmission circuit or the narrowband transmission circuit according to the communication state.

Also, the transmission band is changed according to the wideband transmission state or the narrowband transmission state, thereby changing a buffering method to the external memory of data.

In other words, the present invention of the apparatus equipped with the dynamic reconfiguration processor performing the reconfiguration for each packet based on the communication state between the terminals is configured to perform the change while in the communication state according to whether the data transmission amount exceeds the receive buffer of the data delivery designation terminal and perform the reconfiguration of the dynamic reconfiguration processing unit, the control of the transmission band, and the buffering to the data memory, etc., based on the changed communication state.

That is, the present invention relates to an information processing apparatus that processes a packet transmitted and received via a network, the information processing apparatus including: a communication state table that stores a communication state between terminals transmitting and receiving packets; a communication state renewing unit that changes the communication state according to a combination of internal information on the received packet and a communication state read from the communication state table based on the internal information on the packet; a dynamic reconfiguration unit that includes an operation matrix having a group of operators whose functions and wirings are different and plural pieces of configuration information accumulation buffers storing configuration information on the operation matrix to receive the packet and the changed communication state, obtains the configuration information from the configuration information accumulation buffer based on the changed communication state, and reconfigures the functions and wirings of the group of the operators in the operation matrix based on the obtained configuration information; and a communication state renewing unit in an output data feedback scheme that performs the change in the communication state based on the data output from the dynamic reconfiguration processing unit so as to perform the change in the communication state according to whether a data transmission amount exceeds a receive buffer amount of a data delivery designation terminal and to perform the reconfiguration of the dynamic reconfiguration processing unit and a control of a transmission band based on the changed communication state, whereby the functions and wirings of the group of operators in the operation matrix are reconfigured based on the changed communication state using the data output from the dynamic reconfiguration processing unit.

Also, the information processing apparatus of the present invention includes a transmission amount counter that counts the transmitted data amount for each communication state after the communication start; and a transmission amount determining unit that compares the transmitted data amount and the preset threshold value, wherein the transmission amount determining unit includes a transmission state changing unit changing the communication state when it is determined that the transmitted data amount is larger than the threshold value and reconfigures the functions and wirings of the group of the operators in the operation matrix based on the communication state changed according to the transmitted data amount of the dynamic reconfiguration processing unit.

Also, the information processing apparatus of the present invention reconfigures the functions and wirings of the group of operators in the operation matrix to be operated as the logic circuit performing the wideband transmission process on the data when the transmitted data amount is smaller than the threshold value and reconfigures the functions and wirings of the group of operators in the operation matrix to be operated as the logic circuit performing the narrowband transmission process on the data when the transmitted data amount is larger than the threshold value.

In this specification, it is noted as a term representing the wideband transmission, “burst” or “BURST” may be used. This is because in the wideband transmission is a large amount of data transmitted in a burst manner. Also, it is noted as a term representing the narrowband transmission, “static” or “STATIC” may be used. This means that data can normally be transmitted in the narrowband transmission, not the above-mentioned wideband transmission.

It is noted that the communication state renewing unit changing the communication state according to a combination of the internal information of the received packet and the communication state read from the communication state table based on the internal information of the packet is called a first communication state renewing unit and the communication state renewing unit changing the communication state using the data output from the dynamic reconfiguration processing unit is called a second communication state renewing unit.

The present invention can provide an information processing apparatus and an information processing system that is capable of delivering data required in the terminals with a high-speed response.

Specifically, the present invention can provide the information processing apparatus and the information processing system that is capable of providing VOD service with a high-speed response from the time of the playing instruction to the playing start.

When the VOD service is provided by appropriately configuring the information processing apparatus equipped with the dynamic reconfiguration processor of the present invention, the present invention can reconfigure the dynamic reconfiguration processing unit to be operated as the logic circuit performing wideband transmission when the data transmission amount is smaller than the receive buffer of the data delivery designation terminal and can configure the dynamic reconfiguration processing unit to be operated as the logic circuit performing the narrowband transmission when the data transmission amount exceeds the receive buffer of the delivery designation terminal. As a result, the VOD service can make the response time from the playing start instruction/playing point change to the actual playing start fast when using a small size and power saving apparatus.

### BRIEF DESCRIPTION OF THE DRAWINGS

FIG. 1A is a block view of a configuration of a packet I/O according to a first embodiment of the present invention;

FIG. 1B is a block view of a configuration of a many-core processor according to the first embodiment of the present invention;

FIG. 1C is a block view of a configuration of a memory according to the first embodiment of the present invention;

FIG. 2 is a block view of a configuration of an information processing apparatus according to the first embodiment of the present invention;

FIG. 3 is a view for explaining a system to which the first embodiment is applied;

FIG. 4 is a view for explaining a system to which the first embodiment is applied;

FIG. 5 is a block view of a configuration of the many-core processor according to the first embodiment of the present invention;

FIG. 6 is a view for explaining one example of a block of a configuration of an operation matrix according to the first embodiment;

FIG. 7 is a view for explaining one example of a block of a configuration of an operation matrix according to the first embodiment;

FIG. 8 is a view for explaining one example of a block of a configuration of an operation matrix according to the first embodiment;

FIG. 9 is a view for explaining a VOD data accumulation area for wideband transmission according to the first embodiment;

FIG. 10A is a view for explaining a VOD data accumulation area for narrowband transmission according to the first embodiment;

FIG. 10B is a view for explaining a read start address value and a last address of a renewed data area in the VOD data accumulation area for narrowband transmission according to the first embodiment;

FIG. 11 is a view for explaining a packet data in the first embodiment;

FIG. 12 is a view for explaining one example of a communication state table according to the first embodiment;

FIG. 13 is a view for explaining one example of transmission or non-transmission/band setting table according to the first embodiment;

FIG. 14 is a flow chart when determining the data transmission or non-transmission and a transmission capability band for each terminal according to the first embodiment;

FIG. 15 is a flow chart when determining a packet type according to the first embodiment;

FIG. 16 is a flow chart when generating interruption based on the packet type and the transmission capability band according to the first embodiment;

FIG. 17 is a flow chart when changing a communication state in transmitting the packet according to the first embodiment;

FIG. 18 is a flow chart when changing the communication state so as to control the transmission band according to the first embodiment;

FIG. 19A is a view for explaining one example of the transition of the communication state according to the first embodiment;

FIG. 19B is a view for explaining one example of the transition of the communication state according to the first embodiment;

FIG. 20 is a flow chart when filtering the packet based on the communication state and information on the packet description according to the first embodiment;

FIG. 21A is a flow chart 1 showing a cycle of a reconfiguration and processing contents of each configuration based on the communication state according to the first embodiment;

FIG. 21B is a flow chart 2 showing the cycle of the reconfiguration and the processing contents of each configuration based on the communication state according to the first embodiment;

FIG. 22A is a flow chart 1 showing the cycle of the reconfiguration and the processing contents of each configuration based on the communication state according to the first embodiment;

FIG. 22B is a flow chart 2 showing the cycle of the reconfiguration and the processing contents of each configuration based on the communication state according to the first embodiment;

FIG. 23 is a flow chart when an HDD data transfer function periodically renews the VOD data area according to the first embodiment;

FIG. 24 is a block view of one configuration of an apparatus equipped with a many-core processor using a packet self-reconfiguration based on the communication state according to the present invention; and

FIG. 25 is a view for explaining one example of making a response speed of a VOD delivery fast according to the present invention.

### DETAILED DESCRIPTION OF THE INVENTION

Hereinafter, the embodiment of the present invention will be described with respect to the accompanying drawings.

### First Embodiment

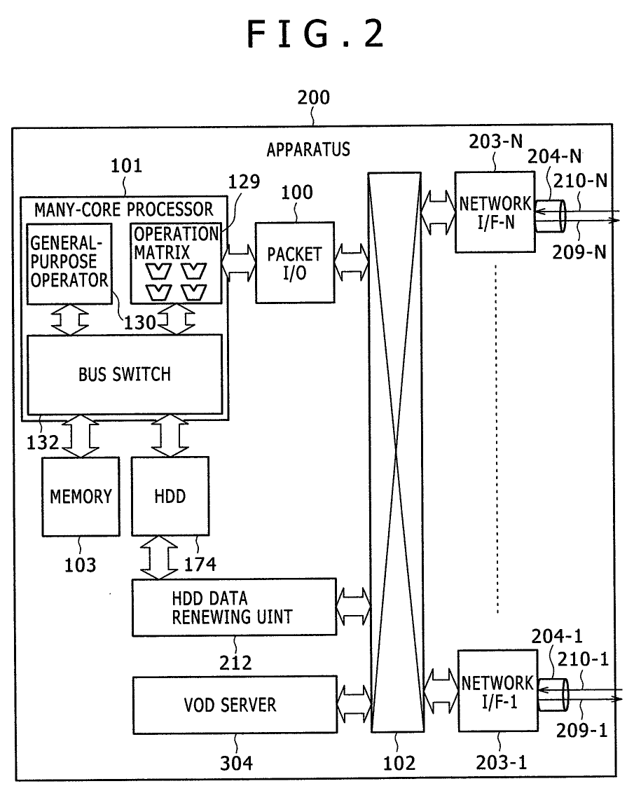

First, an information processing apparatus of a first example is described. FIG. 2 is a block view of a configuration of an information processing apparatus according to the first embodiment of the present invention.

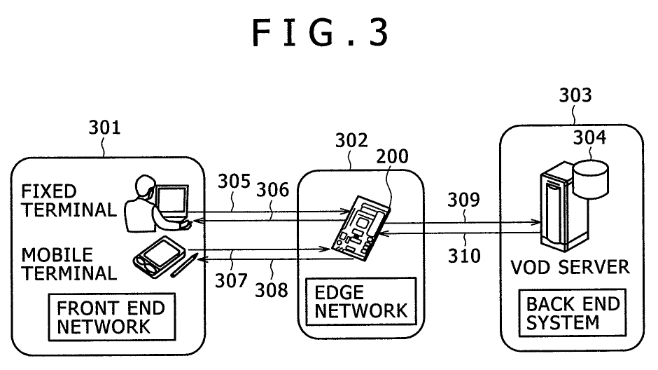

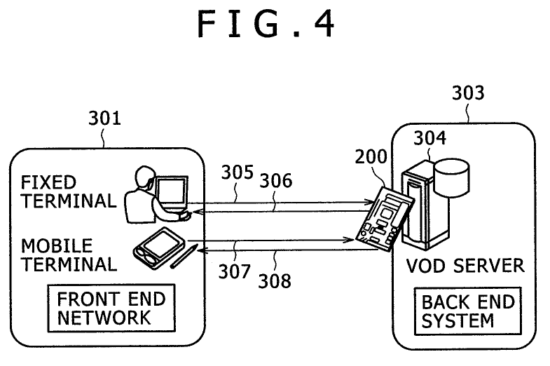

An information processing apparatus 200 includes a many-core processor 101 as a dynamic reconfiguration processing unit, a packet input/output unit (packet I/O) 100, a memory 103 being a storage unit, a network I/F-i (i=1 to N) 203 (203-1 to 203-N), a communication line connection unit 204 (204-1 to 204-N), and a switch 102. The information processing apparatus 200 used for a back end system of FIG. 4 to be described below may become a configuration including an HDD 174, an HDD data renewing unit 212, and a VOD server 304. The information processing apparatus used for an edge network of FIG. 3 to be described below may be a configuration exemplified without including the VOD server 304, the HDD 174, and the HDD data renewing unit 212.

The apparatus 200 is connected to a network to transmit packets received (210-1 to 210-N) from the network via a network I/F 203 to a packet I/O 100 or another network I/F 203. The apparatus 200 transmits (209-1 to 209-N) the packets from the packet I/O 100 and the network I/F 203 to the network via the network I/F 203.

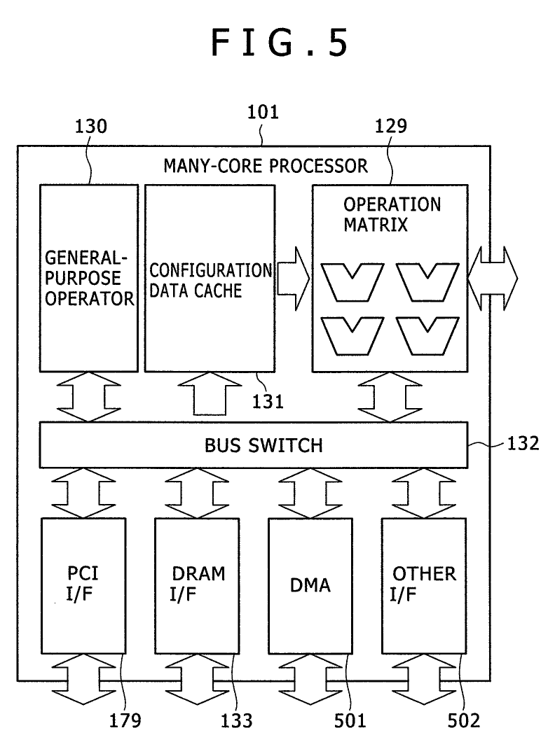

FIG. 5 is a block view of a detailed configuration of the many-core processor 101 as the dynamic reconfiguration processing unit equipped with the apparatus 200.

The many-core processor 101 as the dynamic reconfiguration processing unit includes a general-purpose operator 130, such as an RISC processor, etc., an operation matrix (PE matrix) 129 equipped with plural small operators whose functions and wirings are different from each other, a bus switch 132, a configuration data cache 131 that accumulates configuration data using the operation matrix 129, a PCI I/F 179 for a PCI bus connection, an SDRAM I/F 133 for an external memory access, a DMA controller 501 for a DMA transmission, and other I/F 502 to be connected with other interfaces.

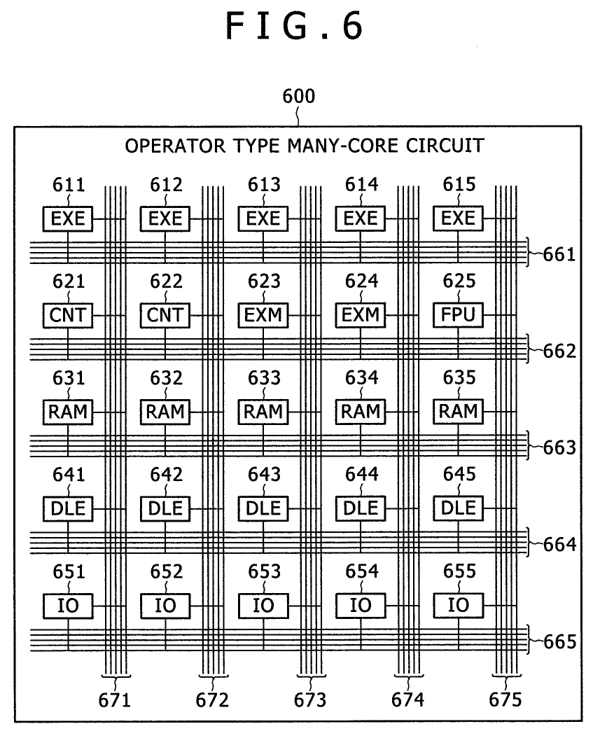

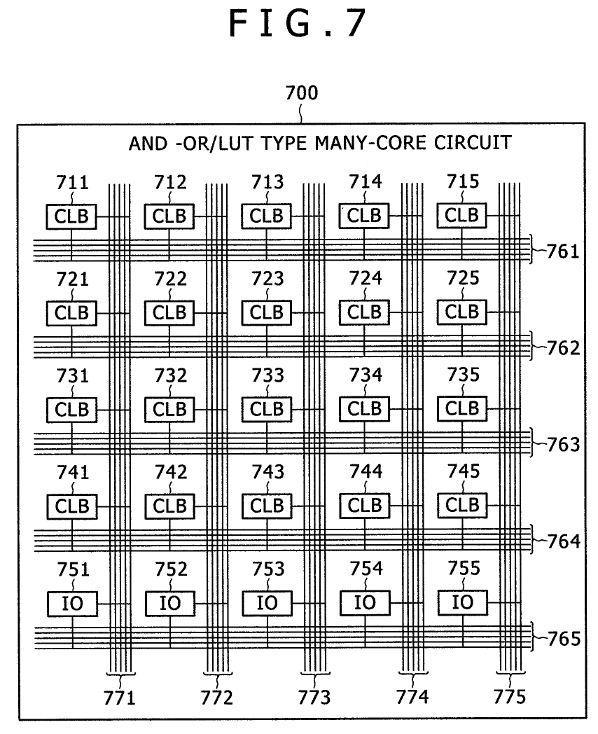

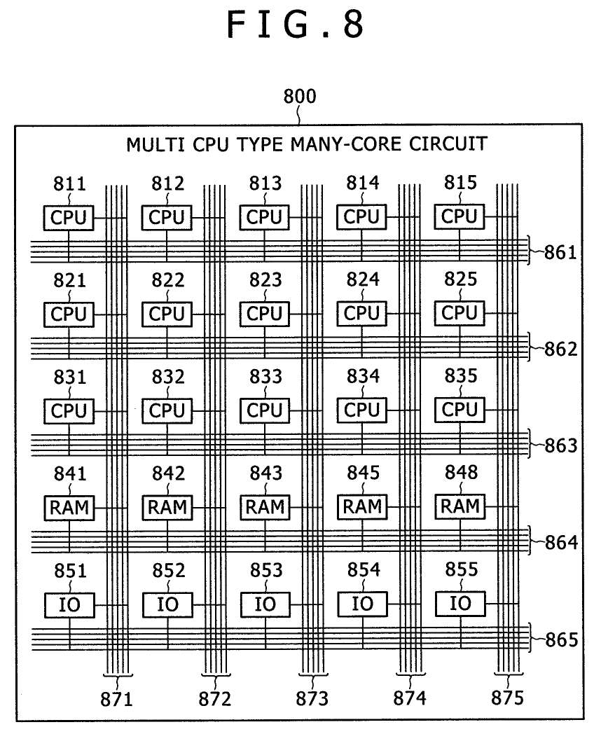

FIGS. 6 to 8 show an example of a block view of the operation matrix 129. FIG. 6 shows an example of an operator-type many-core circuit 600, FIG. 7 shows an example of an AND-OR/LUT (Look up Table)-type many-core circuit 700 and FIG. 8 shows a multi CPU type many-core circuit 800.

The operator-type many-core circuit 600 of FIG. 6 includes operator-type function blocks. Each function block has an input/output of relatively large bits, such as, 8, 16, and 32 bits, etc., and includes EXE blocks 611 to 615 that perform four arithmetic operations on a preset integer, CNT blocks 621 and 622 that have a counter function, EXM blocks 623 and 624 that performs multiplication of an integer, an FPU block 625 that performs a floating point operation, RAM blocks 631 to 635 that perform data accumulation, DLE blocks 641 to 645 that delay and output an input data by a designated block, IO blocks 651 to 655 that input and output data to and from external circuits, or the like. The input/output of data between each function block can be performed by wiring lines 661 to 665 and 671 to 675. Also, the input/output of data are limited between adjacent blocks to limit the wiring length, making it possible to improve an operational frequency.

The AND-OR/LUT-type many-core circuit 700 of FIG. 7 includes an AND-OR/LUT-type function block. Each function block has an input/output of relatively small bits, such as 1, 2, 4, and 6 bits, etc., and includes CLB (cell logic block) blocks 711 to 715, 721 to 725, 731 to 735, 741 to 745 that output a predefined bit pattern according to an input bit pattern, IO blocks 751 to 755 that input and output data to and from external circuits, or the like. The input/output of data between each function block can be performed by wirings 761 to 765 and 771 to 775. Also, the AND-OR/LUT-type many-core circuit 700 of FIG. 7 may be configured of a mixed-type circuit with the operator-type many-core circuit 600 of FIG. 6.

A multi CPU (central processing unit)-type many-core circuit 800 of FIG. 8 includes a CPU-type function block. Each function block has an input/output of relatively large bits, such as, 8, 16, and 32 bits, etc., and includes CPU blocks 811 to 815, 821 to 825, and 831 to 835 that perform various operation processes according to an instruction previously accumulated in an internal cache, RAM blocks 841 to 845 that perform data accumulation, IO blocks 851 to 855 that input and output data to and from external circuits, or the like. The input/output between each function block can be performed by wiring lines 861 to 865 and 871 to 875. Further, the input/output of data are limited between adjacent blocks to limit the wiring length, making it possible to improve an operational frequency.

FIG. 3 shows an example where the information processing apparatus 200 of the present embodiment is used on the network.

The apparatus 200 is arranged on an edge network 302 between a front end network 301 and a back end system 303. The back end system 303 is arranged with the VOD server 304 being a back end terminal.

When the apparatus 200 receives VOD data delivery requesting packets 305 and 307 from a fixed/mobile terminal, it requests necessary data to the VOD server 304 based on a HTTP command, etc. of the packet description (309) and performs a change in data accumulated in a main memory in the apparatus while downloading the necessary VOD data point by point (310), thereby performing the delivery of the VOD data (306/308). The HDD data renewing unit 212 shown in FIG. 2 previously downloads the entire contents of the VOD server 304 (310) and stores the downloaded contents in the hard disk (HDD) 174 in the apparatus, thereby performing the delivery of the VOD data (306/308).

FIG. 4 shows an example where the information processing apparatus 200 of the present embodiment is used in the back end system.

The apparatus 200 is arranged in the back end system 303 including the server 304. At this time, as shown in FIG. 2, the server 304 is connected to the switch 102 of the apparatus 200.

Next, the operations of the many-core processor 101 as the dynamic reconfiguration processing unit, the packet I/O 100, the memory 103, and the HDD 174 of the information processing apparatus 200 of the present embodiment shown in FIG. 2 will be described.

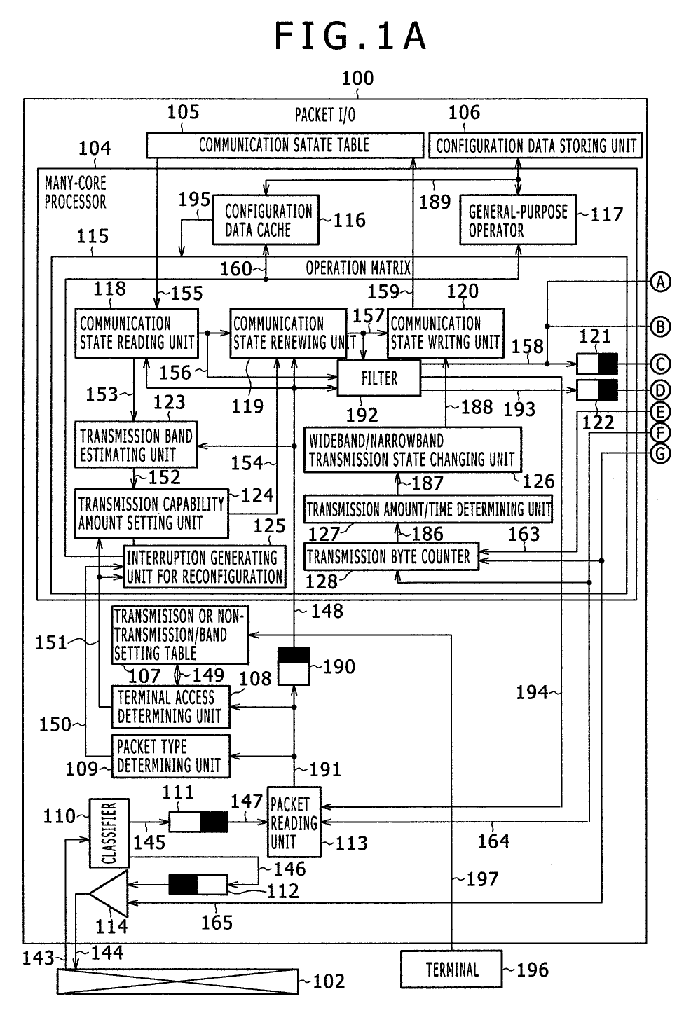

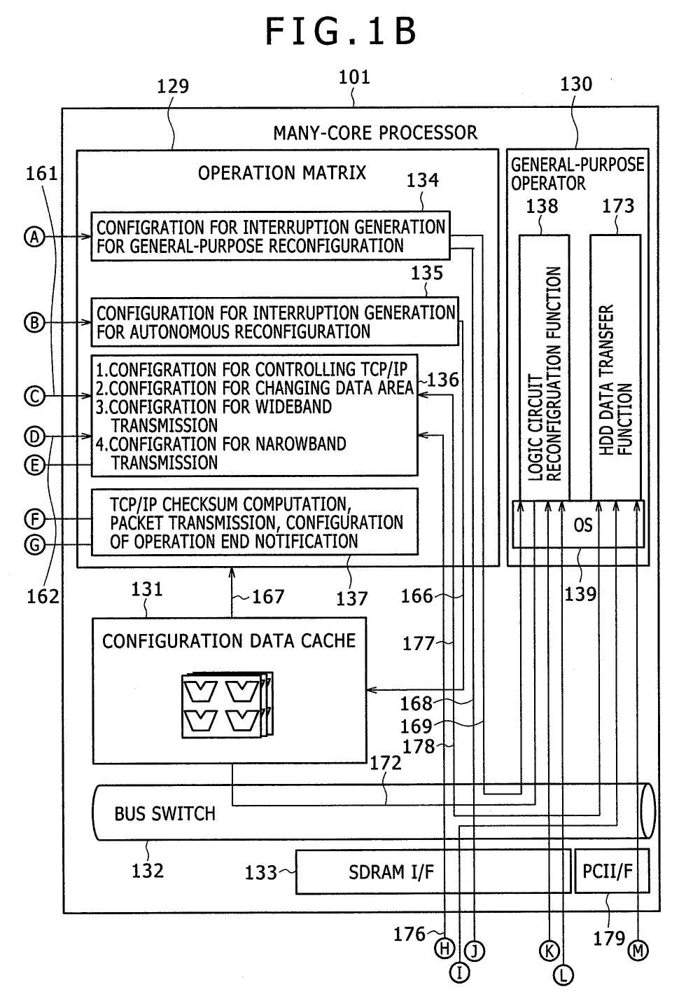

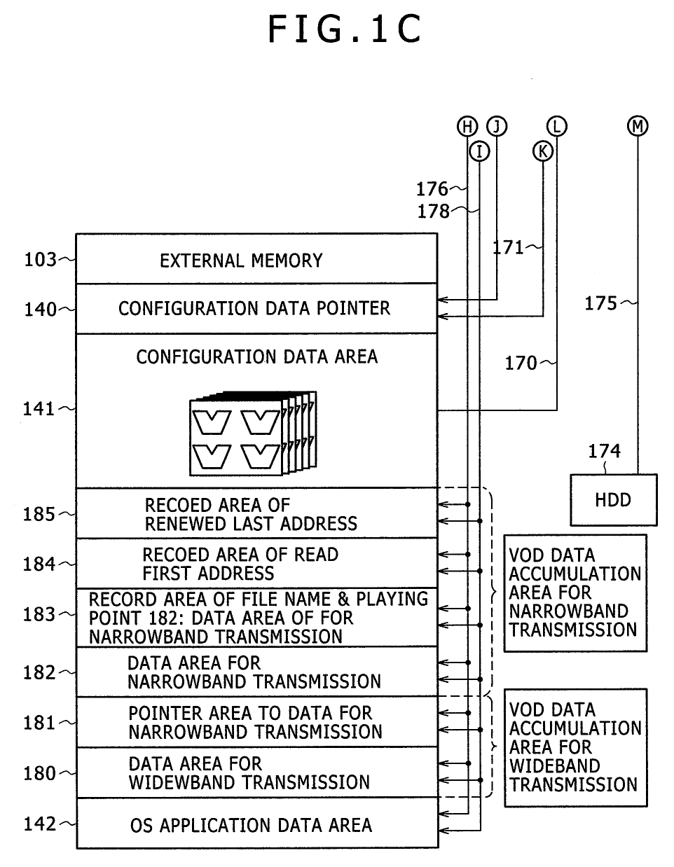

FIG. 1 is a block view of a detailed configuration of one concrete example of the many-core processor 101 as the dynamic reconfiguration processing unit, the packet I/O 100, and the memory 103 of the present embodiment.

The packet I/O 100 includes a classifier 110 connected to the switch 102 that performs a determination on whether packets are to be processed or not and a classification of packets to be processed, a packet buffer 111 that accumulates the packets to be processed, a packet buffer 112 that accumulates packets on which process should not be performed, a packet reading unit 113 that reads packets from the packet buffer 111, a packet buffer 190 that temporarily accumulates the packets read from the packet reading unit 113, a packet type determining unit 109 that determines a received packet type, a transmission or non-transmission/band setting table 107 that writes permission/prohibition and transmission capability band of data transmission for each terminal, a terminal access determining unit 108 that reads the permission/prohibition and the transmission capability band of the data transmission for each terminal from the transmission or non-transmission/band setting table 107 based on internal information on the receive packet, a communication state table 105 that performs the accumulation of the communication state, a many-core processor 104 that mainly performs a change in the communication state, a configuration data storage unit 106 that records configuration data for the many-core processor 104, and a concentrator 114 that concentrates and outputs the packets. Also, the terminal 196 is used to change the contents of the transmission or non-transmission/band setting table 107 from the outside as described below.

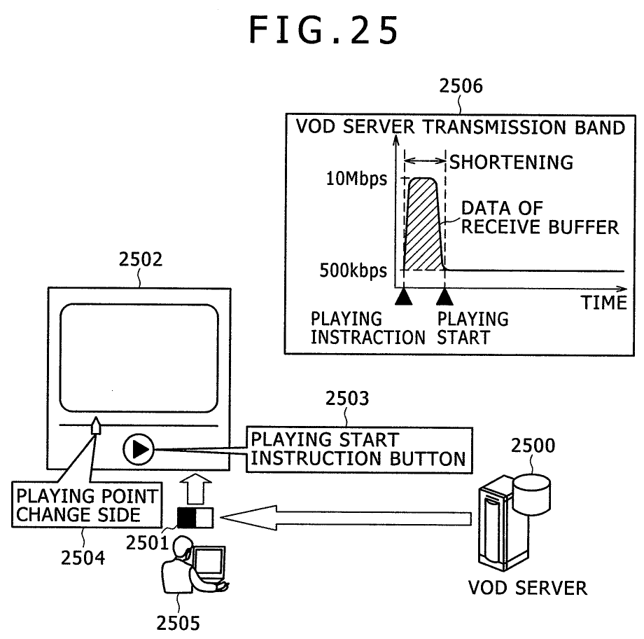

The many-core processor 104 includes a general-purpose operator 117, an operation matrix 115 equipped with plural small operators whose functions and wirings are different from each other, and a configuration data cache 116 that accumulates configuration data for the operation matrix. The operation matrix 115 equipped with plural operators includes a communication state reading unit 118, a communication state renewing unit 119, a communication state writing unit 120, an interruption generating unit for reconfiguration 125 that generates an interruption for reconfiguring based on the permission/prohibition and the transmission capability band of the data transmission for each terminal and the packet type, a transmission band estimating unit 123 that estimates an average transmission band based on the internal information on the receive packet description and the read communication state, a transmission capability amount setting unit 124 that sets the transmission capability amount based on the permission/prohibition and the transmission capability band of the data transmission for each terminal and the average transmission band, a filter 192 that filters the packets based on the internal information on the packet description and the communication state, a transmission byte counter 128 that counts the packet transmission amount for each transmission destination terminal, a transmission amount/time determining unit 127 that compares packet transmission amount or packet transmission time with a preset threshold value, a wideband/narrowband transmission state changing unit 126 that changes the communication state from a wide transmission state to a narrow band transmission state, a communication state buffer 121 that temporarily accumulates the changed communication state, a receive buffer 122 that temporarily accumulates the receive packets. The operation matrix 115 includes a function of the communication state renewing unit and a function of the transmission state changing unit as described below. Also, the transmission bands for wideband transmission and narrowband transmission in the present embodiment shows about 20 times difference, such as 10 Mbps and 500 kbps shown in FIG. 25, but are not limited thereto.

The many-core processor 101 as the dynamic reconfiguration processing unit includes a general-purpose operator 130, an operation matrix 129 equipped with plural small operators whose functions and wirings are different from each other, a configuration data cache 131, a bus switch 132, an SDRAM I/F 133 for an external memory access, and a PCI I/F 179 for a PCI bus access.

The external memory 103 includes a configuration data area 141 that accumulates configuration information not being accumulated in the configuration data cache 131, a configuration data pointer 140 that writes an address pointer to configuration data in the configuration data area 141, an O/S application data area 142, a data area for narrowband transmission 182 that accumulates VOD data for narrowband transmission, a record area for a VOD file name and a playing point 183, a record area for read first address 184, a record area for renewed last address 185, a data area for wideband transmission 180 that accumulates VOD data for wideband transmission, and a pointer area 181 that accumulates a pointer of the VOD data area for narrowband transmission.

The general-purpose operator 130 of the many-core processor 101 being the dynamic reconfiguration processing unit performs the OS 139 and calls a logic circuit reconfiguration function 138 upon receiving a trigger for general-purpose reconfiguration 169 generated by the operation matrix 129. The called logic circuit reconfiguration function 138 reads the configuration data from the configuration data area 141 to load the read configuration data into the configuration data cache 131 and to transmit them to the operation matrix 129.

The operation matrix 129 includes a configuration 135 of an interruption generation for autonomous configuration that generates a necessary interruption so that the operation matrix 129 is autonomously reconfigured based on the communication state, a configuration 134 of an interruption generation for general-purpose reconfiguration that generates the interruption for reconfiguration for the general-purpose operator 130, a configuration 136 that performs a TCP/IP control using the communication state and the packet to renew the VOD data areas for transmission 180 to 185 in the memory 103 and to perform the generation and wideband/narrowband transmission of the packet including the VOD data, and a configuration 137 that performs the transmission of the packet after computing a TCP/IP checksum of a newly generated packet and performs a operation end notification after transmitting the entire packet.

Hereinafter, each component of the packet I/O 100, the many-core processor 101 as the dynamic reconfiguration processing unit, and the memory 103 will be described in detail.

The classifier 110 in the packet I/O 100 determines the packets to be processed or not when receiving the packets from the switch 102 (143). In the case of the packets not to be processed, the packets are output to the concentrator 114 (146) and are accumulated in the packet buffer 112. In the case of the packets to be processed, the packets are accumulated in the packet buffer 111 (145).

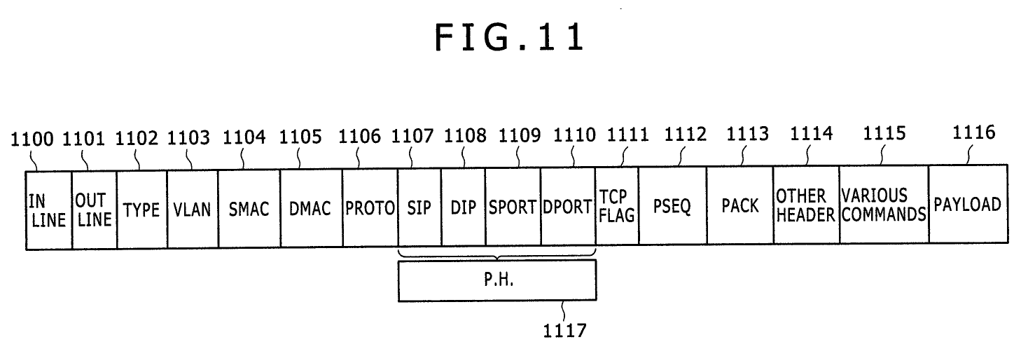

FIG. 11 shows one example of a format of the packet 143 received in the classifier 110 from the switch 102.

The packet 143 includes InLine 1100, OutLine 1101, Type 1102, Vlan 1103, SMAC 1104, DMAC 1105, Proto 1106, SIP 1107, DIP 1108, Sport 1109, Dport 1110, TCP Flag 1111, PSEQ 1112, PACK 1113, OtherHeader 1114, various commanders 1115, and Payload 1116. Also, in the present embodiment, the packet header (Packet Header: P.H.) 1117 is configured of SIP 1107, DIP 1108, Sport 1109, and Dport 1110. The P.H. 1117 shows a characteristic of the packet 143.

Herein, the InLine 1100 stores an input line number which is an identification number of the line that is input to the packets are. The OutLine 1101 stores an output line number which is an identification number of the line that is output to the packets. The Type 1102 stores an identification number for identifying a protocol of a network layer. The Vlan 1103 stores a number for identifying the VLAN. The SMAC 1104 stores a transmission source MAC address, which is a transmission source address of a data link layer. The DMAC 1105 stores a destination MAC address which is a destination address. The Proto 1106 stores an identification number for identifying a protocol of a transport layer, such as a User Datagram Protocol (UDP), etc. The SIP 1107 stores a transmission source address, that is, a transmission source IP address which is an address of a terminal on a transmission side. The DIP 1108 stores a destination address, that is, a destination IP address which is an address of a terminal on a receiving side. The SPORT 1109 stores a transmission port of a TCP. The DPORT 1110 stores a destination port of the TCP. The TCP Flag 1111 stores a TCP flag number. The PSEQ 1112 stores a transmission sequence number (SEQ number). The PACK 1113 stores a receive sequence number (ACK number). The OtherHeader 1114 stores other IP/TCP header data. The various commands 1115 store a command of an application layer. The Payload 1116 stores data other than a packet header and various commands.

The classifier 110 classifies the packets, for example, according to the contents of P.H. 1117, that is, the characteristics of the packets and determines the packets to be processed or not. In the case of the packets on which the process should not be performed, the classifier 110 outputs the packets to the concentrator 114 (146), which are then accumulated in the packet buffer 112. In the case of the packets to be processed, the classifier 110 accumulates the packets in the packet buffer 111 (145).

When the packet reading unit 113 receives the operation end notification 194 from the filter 192 or the operation end notification 164 from the operation matrix 129, it reads the packets accumulated the buffer 111 (147) and transmits the read packets to the packet type determining unit 109 checking the packet type, the terminal access determining unit 108, and the packet buffer 190 (191).

When the terminal access determining unit 108 receives the packets from the packet reading unit 113 (191), it retrieves the transmission or non-transmission/band setting table 107 based on the internal information on the packet description (149) and reads the entry corresponding to the packet. Also, the terminal access determining unit 108 determines the transmission band based on the information on the read entry description.

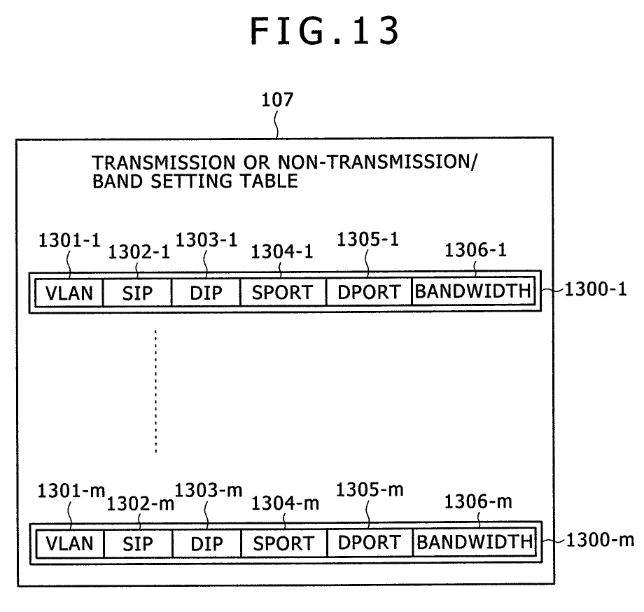

FIG. 13 is a view for explaining one example of the transmission or non-transmission/band setting table 107. The transmission or non-transmission/band setting table 107 includes m entries 1300 (1300-1 to 1300-m).

The entry 1300 is the same as the above-mentioned P.H. 1117 and includes SIP 1302, DIP 1303, SPORT 1304, and DPORT 1305 as well as VLAN 1301 and Bandwidth 1306.

The SIP 1302 records the transmission source address of the communication, that is, the transmission source IP address, which is the address of the host on the transmission side. The DIP 1303 records the designation address of the communication, that is, the designation IP address, which is the address of the host on the receive side. The SPORT 1304 records the transmission source port of the communication. The DPORT 1305 records the TCP designation port of the communication. The VLAN 1301 records the VLAN identification number of the communication. The Bandwidth 1306 records the transmission capability band. If the communication wants to prohibit the transmission, the Bandwidth 1306 records the transmission capability band as ‘0’ The value inside the entry 1300 can be changed according to the external terminal 196 as described above (197).

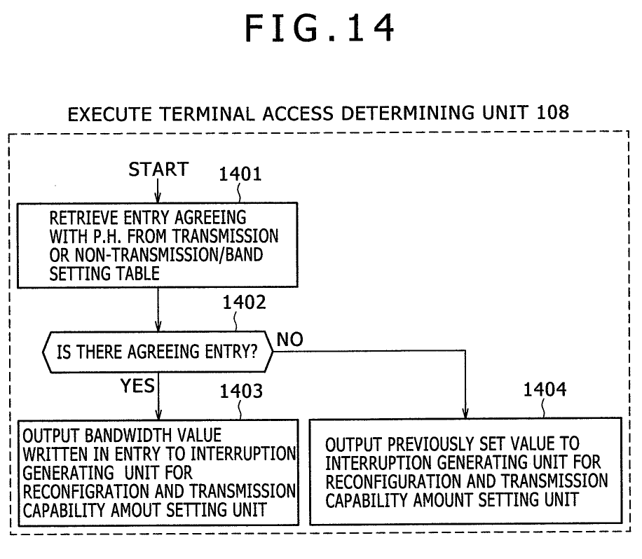

FIG. 14 is a flow chart when the terminal access determining unit 108 reads the entry corresponding to the packet from the transmission or non-transmission/band setting table 107 based on the internal information of the packet description received from the packet reading unit 113 so as to the determine the transmission capability band.

When the terminal access determining unit 108 receives the packets from the packet reading unit 113 (191), it retrieves the entry 1300 (SIP 1302, DIP 1303, SPORT 1304, DPORT 1305) agreeing with P.H. 1117 of the packet description from the transmission or non-transmission/band setting table 107 (step 1401). It is determined whether there is the agreed entry 1300 according to the retrieve results (step 1402). When there is the agreed entry 1300, the transmission capability band Bandwidth 1306 described in the entry 1300 is output to the interruption generation unit for reconfiguration 125 and the transmission capability amount setting unit 124 as the transmission capability band value (151) (step 1403). On the other hand, when there is no agreed entry 1300, the preset transmission capability band value (151) is output to the interruption generating unit for reconfiguration 125 and the transmission capability amount setting unit 124 (step 1404).

When the packet type determining unit 109 receives the packet from the packet reading unit 113 (191), it determines the packet type based on the packet type Type 1102 of the packet description.

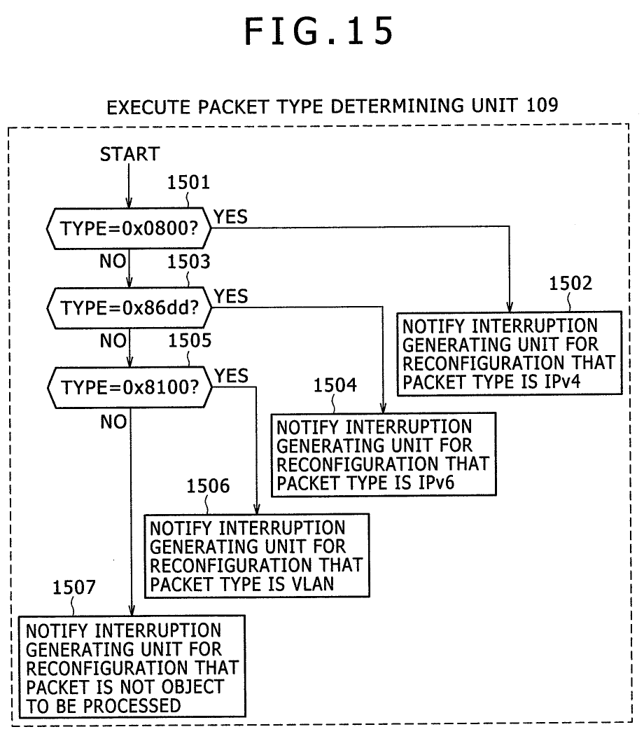

FIG. 15 is a flow chart when the packet type determining unit 109 determines the packet type based on the internal information on the receive packet description.

When the packet type determining unit 109 receives the packet from the packet reading unit 113 (191), it determines whether the value stored in the packet type Type 1102 of the packet description agrees with 0x0800 (step 1501). When agreeing, it notifies the interruption generating unit for reconfiguration 125 that the packet type is IPv4 (150) (step 1502). When not agreeing, it determines whether the value stored in the packet type Type 1102 of the packet description agrees with 0x86dd (step 1503). When agreeing, it notifies the interruption generating unit for reconfiguration 125 that the packet type is IPv6 (150) (step 1504). When not agreeing, it determines whether the value stored in the packet type Type 1102 of the packet description agrees with 0x8100 (step 1505). When agreeing, it notifies the interruption generating unit for reconfiguration 125 that the packet type is VLAN (150) (step 1506). When not agreeing, it notifies the interruption generating unit for reconfiguration 125 that the packet type is other than an object to be processed (150) (step 1507).

The interruption generating unit for reconfiguration 125 is configured by the group of operators in the operation matrix 115. The interruption generating unit for reconfiguration 125 generates the interruption (160) required for reconfiguring the operation matrix 115 based on the transmission capability band 151 received from the terminal access determining unit 108 and the determination result 150 of the packet type received from the packet type determining unit 109.

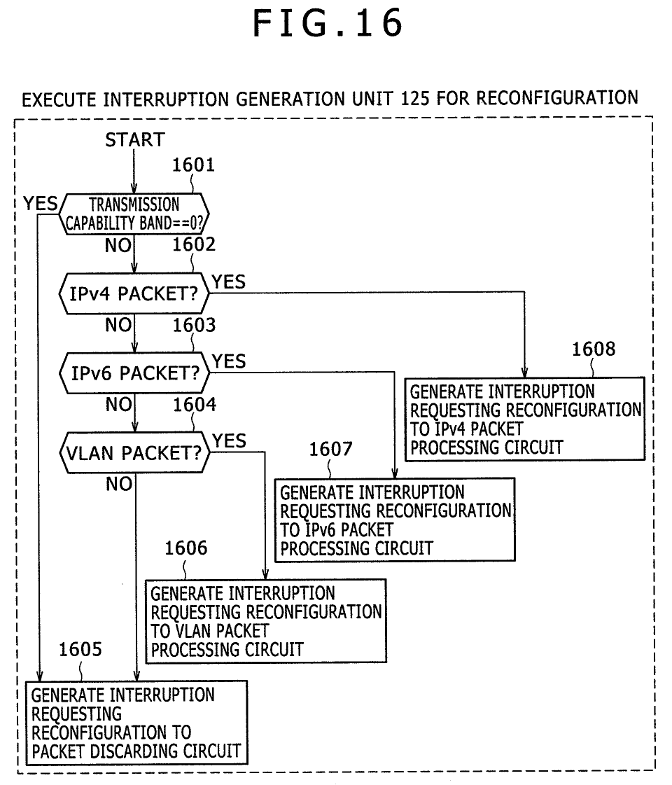

FIG. 16 is a flow chart when the interruption generating unit for reconfiguration 125 generates the interruption (160) required for reconfiguring the operation matrix 115 based on the transmission capability band 151 and the determination result 150 of the packet type.

When the interruption generating unit for reconfiguration 125 receives the transmission capability band 151 and the determination result 150 of the packet type, it determines whether the transmission capability band 151 is ‘0’ (step 1601). When the transmission capability band 151 is ‘0’, the interruption (160) requesting the reconfiguration to the packet filtering circuit is generated (step 1605). When the transmission capability band 151 is not ‘0’, it is determined whether the determination result 150 of the packet type is IPv4 (step 1602). When the determination result is IPv4, the interruption (160) requesting the configuration to the IPv4 packet processing circuit is generated (step 1608). When the determination result is not IPv4, it is determined whether the determination result 150 of the packet type is IPv6 (step 1603). When the determination result is IPv6, the interruption 160 requesting the reconfiguration generates a demand to the IPv6 packet processing circuit (step 1607). When the determination result is not IPv6, it is determined whether the determination result 150 of the packet type is VLAN (step 1604). When the determination result is VLAN, the interruption 160 requesting the reconfiguration generates a demand to the IPv4 packet processing circuit (step 1604). When the determination result is VLAN, the interruption 160 requesting the reconfiguration to the VLAN packet processing circuit is generated (step 1606). When the determination result is not VLAN, the interruption 160 requesting the reconfiguration to the packet filtering circuit is generated (step 1605).

The interruption 160 is generated for the general-purpose operator 117 or the operation matrix 115, itself. When the configuration data used later are not accumulated in the configuration data cache 116, the general-purpose operator 117 reads the configuration data from the configuration data storage unit 106 and transmits the read configuration data to the configuration data cache 116 (189). The general-purpose operator 117 or the operation matrix 115 transmits the configuration data to be used later from the configuration data cache 116 to the operation matrix 115 (195) and reconfigures the wirings and functions of the group of operators in the operation matrix 115 based on the transmitted configuration data 195.

The apparatus 200 performs the above-mentioned processes described with reference to FIGS. 14 to 16, such that the configuration of the operation matrix can be performed based on the received packet type and the permission/prohibition and the transmission capability band of the data transmission previously established for each terminal. As a result, the change in the communication state can be performed using the packet type and the logic circuit optimized for each transmission source.

When the interruption generating unit for reconfiguration 125 generates the interruption 160 requesting the reconfiguration to the packet filtering circuit, the operation matrix 115 is reconfigured as a circuit that reads the packet 148 from the packet buffer 190 and then filters the packet using the filter 192 and outputs the packet end notification 194 to the packet reading unit 113.

When the interruption generating unit for reconfiguration 125 generates the interruption 160 requesting reconfiguration to the IPv4/IPv6/VLAN packet processing circuit, the operation matrix 115 is reconfigured as a circuit optimized for each packet type and performs the change in the communication state of the communication state table 105.

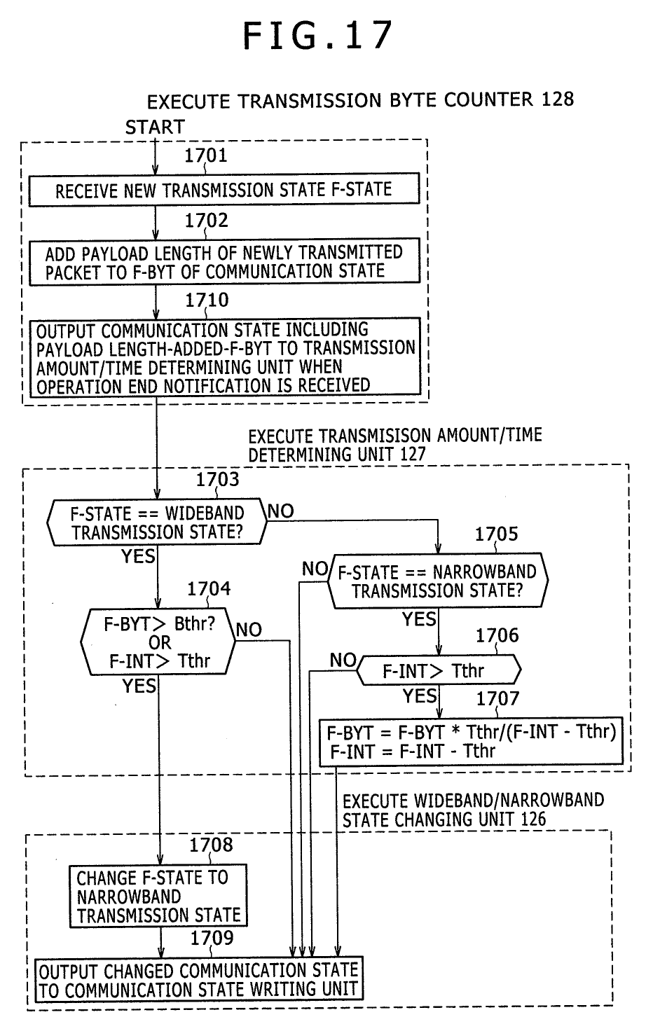

Also, the communication state of the communication state table 105 description is changed by using the receive packet and by using the transmission packet as described below. The former is performed by the communication state reading unit 118, the communication state renewing unit 119, and the communication state writing unit 120 and the latter is performed by the transmission byte counter 128 as described with reference to FIG. 17, the transmission amount/time determining unit 127, and the wideband/narrowband transmission state changing unit 126.

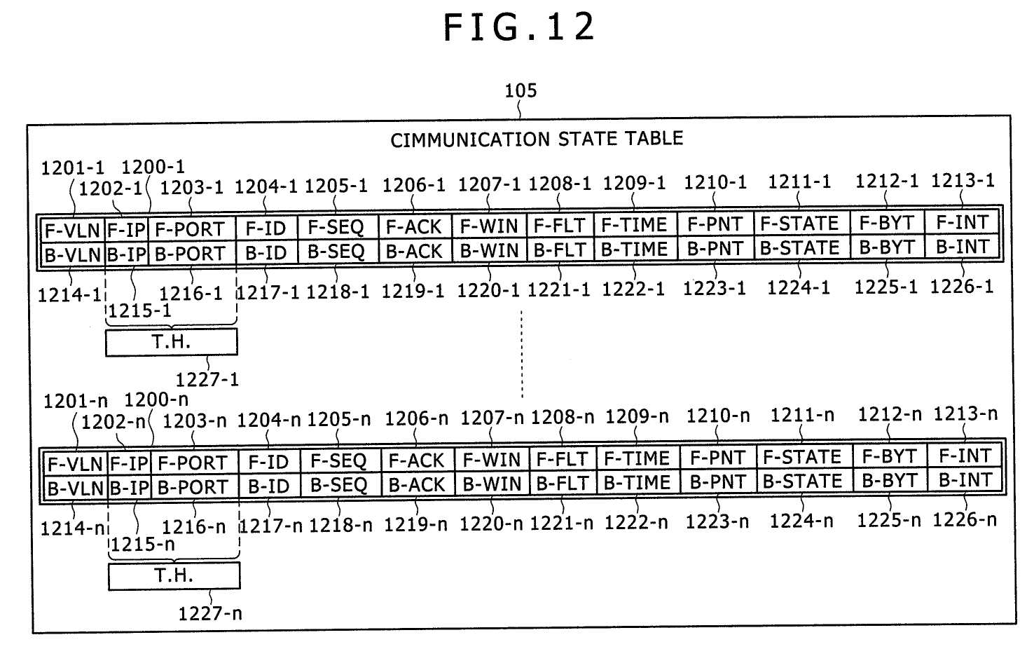

FIG. 12 is a view for explaining one example of the communication state table 105.

The communication state table 105 includes n entries 1200 (1200-1 to 1200-n).

The entry 1200 includes F-VLN 1201, F-IP 1202, F-PORT 1203, F-ID 1204, F-SEQ 1205, F-ACK 1206, F-WIN 1207, F-FLT 1208, F-TIME 1209, F-PNT 1210, F-STATE 1211, F-BYT 1212, F-INT 1213, B-VLN 1214, B-IP 1215, B-PORT 1216, B-ID 1217, B-SEQ 1218, B-ACK 1219, B-WIN 1220, B-FLT 1221, B-TIME 1222, B-PNT 1223, B-STATE 1224, B-BYT 1225, and B-INT 1226.

The F-VLN 1201 records the VLAN identification number used to communicate with the terminal on the front end side. The B-VLN 1214 records the VLAN identification number used to communicate with the terminal on the back end side. The F-IP 1202 records the IP address of the terminal on the front end side. The B-IP 1215 records IP address of the terminal on the back end side. The F-PORT 1203 records the TCP port number of the terminal on the front end side. The B-PORT 1216 records the TCP port number of the terminal on the back end side. The F-ID 1204 records the identification number of the packet transmitted to the terminal on the front end side. The B-ID 1217 records the identification number of the packet transmitted to the terminal on the back end side. The F-SEQ 1205 records the transmission sequence number of the communication with the terminal on the front end side. The B-SEQ 1218 records the transmission sequence number of the communication with the terminal on the back end side. F-ACK 1206 records the receive sequence number of the communication with the terminal on the front end side. The B-ACK 1219 records the receive sequence number of the communication with the terminal on the back end side. The F-WIN1207 records the congestion window size for TCP to be used in the communication with the terminal on the front end side. The B-WIN 1220 records the congestion window size for TCP to be used in the communication with the back end side.

The F-FLT1208 records an arrival unconfirmed transmission amount that is already transmitted to the terminal on the front end side but represents the arrival unconfirmed data size. The B-FLT 1221 records an arrival unconfirmed transmission amount that is already transmitted to the terminal on the back end side but represents the arrival of unconfirmed data size. The F-TIME 1209 records the latest time when the packet was received from the terminal on the front end side. The B-TIME 1222 records the latest time when the packet was received from the terminal on the back end side. The F-PNT 1210 records the address pointer for using the PE group 136 that executes the TCP/IP control or the wideband/narrowband transmission when the packet is received from the terminal on the front end side. The B-PNT 1223 records the address pointer for using the PE group 136 that executes the renewal of the VOD data area within the memory 103 when the packet is received from the terminal on the back end side. The F-STATE 1211 records the communication state (the communication un-established state, the communication established state, the narrowband transmission state, and the wideband transmission state, etc.) established between the front end terminals by the apparatus 200. The B-STATE 1224 records the communication state established between the back end terminals by the apparatus 200. The F-BYT 1212 records the packet byte integrated amount transmitted to the terminal on the front end side after communication is established. The B-BYT 1225 records the packet byte integrated amount transmitted to the terminal on the back end side after communication is established. The F-INT 1213 records the elapsed time after the demand of the data delivery is received from the terminal on the front end side. The B-INT 1226 records the elapsed time after the demand of the data delivery is received from the terminal on the back end side. Also, in the present embodiment, the table header (Table Header: T.H.) 1227 is configured of F-IP 1202, B-IP 1215, and F-PORT 1203, and B-PORT 1216.

Next, the change in the communication state of the communication state table 105 description is described. First, the change in the communication state using the transmission packet will be described.

The change in the communication state using the transmission packet is executed by the transmission byte counter 128, the transmission amount/time determining unit 127, and the wideband/normal state changing unit 126.

FIG. 17 is a flow chart showing the change in the communication state based on the transmission packet executed by the transmission byte counter 128, the transmission amount/time determining unit 127, and the wideband/normal state changing unit 126.

When the transmission byte counter 128 receives a new communication state 163 from the configuration for controlling TCP/IP and renewing VOD data area and transmitting VOD data 136 (step 1701), it adds a payload length of packet 165 to the byte integrated amount F-BYT 1212 of the communication state 163 description whenever the packet 165 transmitted from the configuration for computing TCP/IP checksum and transmitting packet and notifying operation end 137 is received (step 1702). A communication state 186 including the byte integrated amount F-BYT 1212 added with the payload length is output to the transmission amount/time determining unit 127 when an operation end notification 164 is received from the configuration for computing TCP/IP checksum and transmitting packet and notifying operation end 137 (step 1710).

When the transmission amount/time determining unit 127 receives the communication state 186 from the transmission byte counter 128, it determines whether the communication state value F-STATE 1211 of the communication state 186 description is the wideband transmission state (step 1703). When the state value F-STATE 1211 is a value representing the wideband transmission state, it is determined whether the byte integrated amount F-BYT 1212 of the communication state 186 description exceeds a preset threshold value Bthr (step 1704). Also, when it is determined that the elapsed time F-INT 1213 of the communication state 186 description exceeds a preset threshold value Tthr, the determination result is output to the wideband/narrowband transmission state changing unit 126 (187) (step 1704). Also, when it is determined that the communication state value F-STATE 1211 does not have the value representing the wideband transmission state at the step 1703, it is determined whether the communication state F-STATE 1211 of the communication state 186 description is the narrowband transmission state (step 1705). When the communication state F-STATE 1211 is the narrowband transmission state, it is determined whether the elapsed time F-INT 1213 of the communication state 186 description exceeds the preset threshold value Tthr (step 1706). When exceeding, after the byte integrated amount F-BYT 1212 of the communication state description becomes Tthr times, it is divided by a difference between the elapsed time F-INT 1213 and the Tthr and is then averaged, such that the elapsed time F-INT 1213 is subtracted by the Tthr (step 1707). Finally, the changed communication state is output to the wideband/narrowband transmission state changing unit 126 (187).

When the determination result is “excess” at step 1704, the wideband/narrowband transmission state changing unit 126 changes the communication state value F-STATE 1211 of the communication state description to the value representing the narrowband transmission state (step 1708). Finally, the changed communication state is output to the communication state writing unit 120 (188) (step 1709).

The above-mentioned processes described with reference to FIG. 17 are executed by the apparatus 200, such that the change in the communication state using the transmission packet can be realized.

Next, the change in the communication state for controlling the transmission band and the change in the communication state using the receive packet will be described.

The change in the communication state using the receive packet is mainly achieved by the communication state reading unit 118, the communication state renewing unit 119, and the communication state writing unit 120 and only the change in the communication state about the transmission band control is achieved by the transmission band estimating unit 123 and the transmission capability amount setting unit 124.

After the operation matrix 115 is reconfigured as the circuit optimized for each packet type, it reads the packet received from the packet buffer 190 (148) and outputs the read packet 148 to the communication state reading unit 118, the transmission band estimating unit 123, the communication state renewing unit 119, and the filter 192.

The communication state reading unit 118 reads the entry 1200 having the T.H. 1227 agreeing with the P.H. 1117 of the packet description from the communication state table 105 (155). When the entry 1200 having the T.H. 1227 agreeing with the P.H. 1117 of the packet description does not exist in the communication state table 105, the entry 1200 having the T.H. 1227 agreeing with the P.H. 1117 of the packet description is newly prepared. The read and prepared entry 1200 is output to the communication state renewing unit 119 and the filter 192 as the communication state 156 and is also output to the transmission band estimating unit 123 as the communication state 153.

The transmission band estimating unit 123 computes the average transmission band B_{S} and the arrival unconfirmed transmission amount F-FLT 1208 using the communication state 153 output by the communication state reading unit 118 and the packet 148 read from the packet buffer 190 to be output to the transmission capability setting unit 124 (152).

Also, the transmission capability amount setting unit 124 corrects the value of the congestion window size F-WIN 1207 of the communication state description based on the average transmission band B_{S} and the arrival unconfirmed transmission amount F-FLT 1208 computed by the transmission band estimating unit 123 and the transmission capability band value 151 output by the terminal access determining unit 108. The value of the corrected congestion window size F-WIN 1207 is output to the communication state renewing unit 119 as the transmission capability amount 154.

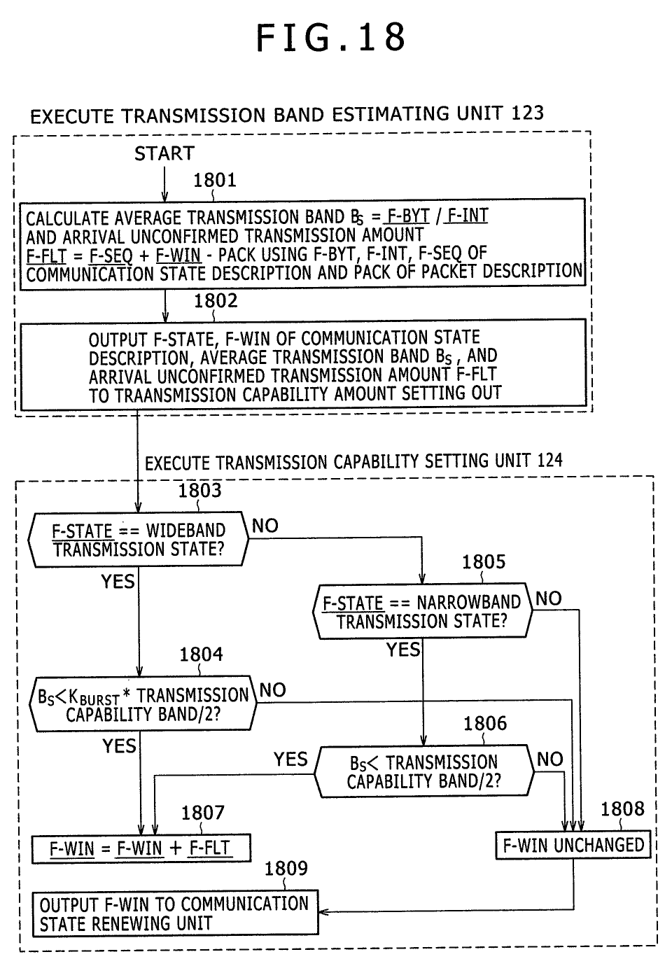

FIG. 18 is a flow chart executing the transmission band estimating unit 123 and the transmission capability amount setting unit 124.

The transmission capability setting unit 123 computes the average transmission band B_{S}=F-BYT 1212/F-INT 1213 and the arrival unconfirmed transmission amount F-FLT 1208=F-SEQ 1205+F-WIN 1207−PACK 1113 for the terminal transmitting the packet by using the byte integrated amount F-BYT 1212-1, the elapsed time F-INT 1213-1, and the transmission sequence number F-SEQ 1205-1 of the communication state 153 description output by the communication state reading unit 118 and the receive sequence number PACK 1113 of the read packet 148 description from the packet buffer 190 (step 1801). Also, the communication state value F-STATE 1211 and the congestion window size F-WIN 1207 of the communication state 153 description and the computed average transmission band B_{S} and the arrival unconfirmed transmission amount F-FLT 1208 are output to the transmission capability amount setting unit 124 (step 1802).

When the transmission capability amount setting unit 124 receives the average transmission band B_{S} and the arrival unconfirmed transmission amount F-FLT 1208 computed by the transmission band estimating unit 123, the communication state value F-STATE 1211 and the congestion window size F-WIN 1207 of the communication state 153 description, and the transmission capability band value 151 output by the terminal access determining unit 108, it is first determined whether the communication state value F-STATE 1211 is the wideband transmission state (step 1803). When the communication state vale F-STATE 1211 is the wideband transmission state, it is determined whether the average transmission band B_{S} is smaller than a value obtained by dividing the integrated value of the preset coefficient Kburst and the transmission capability band value 151 by ‘2’ (step 1804). When it is determined that the average transmission band B_{S} is smaller than the value, the value adding the arrival unconfirmed transmission amount F-FLT 1208 to the congestion window size F-WIN 1207 is output (step 1809) to the communication state renewing unit 119 as the new congestion window size F-WIN 1207 (step 1807). When it is determined that the average transmission band B_{S} agrees with or larger than the value at step 1804, the added value is output (step 1809) to the communication state renewing value 119 without changing the value of the congestion window size F-WIN 1207 (step 1808). At step 1803, when it is determined that the communication state value F-STATE 1211 is not the wideband transmission state, it is determined whether the communication state F-STATE 1211 is the narrowband transmission state (step 1805). When the F-STATE 1211 is the narrowband transmission state, it is determined whether the average transmission band B_{S} is smaller than a value obtained by dividing the transmission capability band value 151 by ‘2’ (step 1806). When it is determined that the average transmission band B_{S} is smaller than the value, the value adding the arrival unconfirmed transmission amount F-FLT 1208 to the congestion window size F-WIN 1207 is output (step 1809) to the communication state renewing unit 119 as the new congestion window size F-WIN 1207 (step 1807). When it is determined that the average transmission band B_{S} agrees with or is larger than the value at step 1806, the added value is output (step 1809) to the communication state renewing value 119 without changing the value of the congestion window size F-WIN 1207 (step 1808).

As described above, the congestion window size F-WIN 1207 used for controlling the transmission band is corrected, which is then output to the communication state renewing unit 119 as the transmission capability amount 154.

The communication state renewing unit 119 changes the communication state 156 based on the communication state 156 received from the communication state reading unit 118, the receive packet 148 read from the packet buffer 190, and the transmission capability amount 154 received from the transmission capability setting unit 124.

The communication state renewing unit 119 changes the value of the F-SEQ 1205 using the value of the PACK 1113 only when the difference of the PACK 1113 of the receive packet 148 description and the F-SEQ 1205 of the communication state 156 is between the preset value Wthr and ‘0’. The F/B-INT 1213/1226 is added with the difference of the present time and the F/B-TIME 1209/1222. The F/B-TIME 1209/1222 is described with the present time.

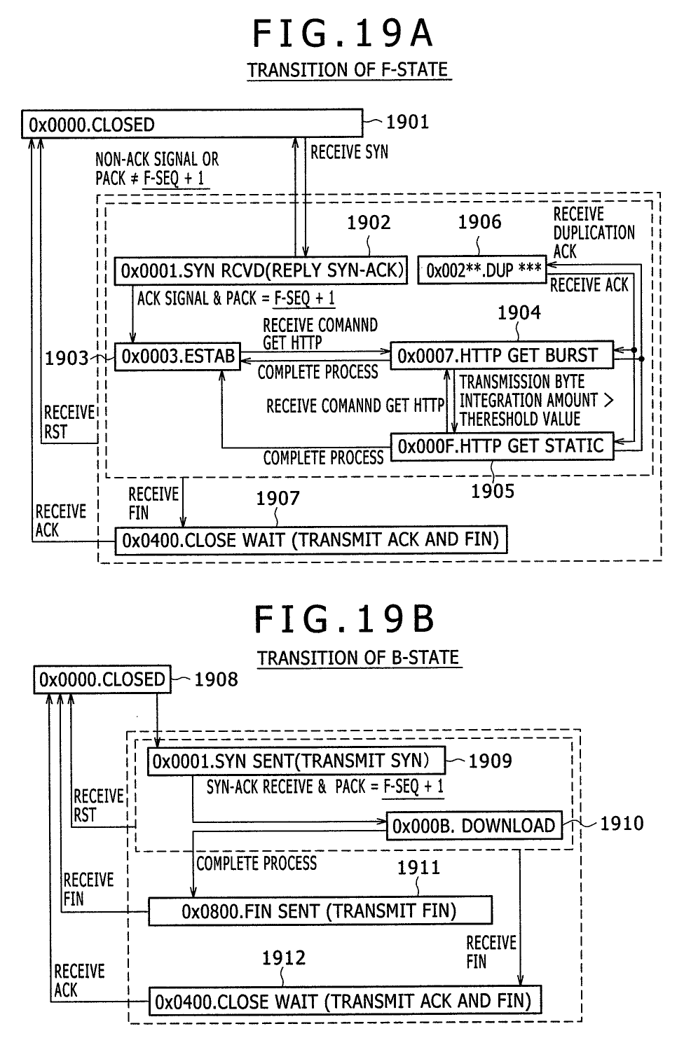

FIGS. 19A and 19B show one example of the transition of the state value F-STATE 1211 and B-STATE of each communication state.

In FIG. 19A, the communication state value F-STATE 1211 is a value ‘0x0000’ representing the communication un-established state CLOSED to begin with (state 1901). When the TCP-Flag 1111 receives the packet of ACK and receives the packet of SYN, it transitions the packet to a value ‘0x0000’ representing a connection requesting communication state SYN RCVD so as to reply to the packet where SYN-ACK is described in the TCP-Flag 1111 (state 1902). Thereafter, when the PACK 1113 of the packet of ACK received by the TCP-Flag 1111 is equal to F-SEQ 1205+‘1’, the communication state value F-STATE 1211 is transitioned to a value “0x0003” representing communication established state ESTAB (state 1903). When other packets are received, it returns to a value “0x0000” representing a communication un-established state CLOSED (state 1901). A packet where GET command according to a hypertext transfer protocol (HTTP) is described in Payload 1116 is received in a state where the communication state value F-STATE 1211 is transitioned to the value “0x0003” representing the communication established state ESTAB, the communication state value F-STATE 1211 is transitioned to a value ‘0x0007’ representing a wideband transmission state HTTP GET BURST (state 1904). When the byte integrated value F-STATE 1212 exceeds the threshold value Bthr in a state where the communication state F-STATE 1211 is transitioned to a value ‘0x0007’ representing the wideband transmission state HTTP GET BURST, the communication state value F-STATE 1211 is transitioned to a value ‘0x000F’ representing a narrow band transmission state HTTP GET STATIC (the transition is executed by a burst/narrowband transmission state changing unit 126) (state 1905). When a packet where the GET command according to the HTTP is described in the Payload 1116 is received in a state where the communication state value F-STATE 1211 is transitioned to the value “0x000F” representing the narrowband transmission state HTTP GET STATIC, the communication state value F-STATE 1211 returns to the value ‘0x0007’ representing the wideband transmission state HTTP GET BURST (state 1904). When the received packet PACK 1113 is equal to the F-SEQ 1205 and has the same value as the previously received packet 1113 in a state where the communication state value F-STATE 1211 is transitioned to the value ‘0x0007’ representing the wideband transmission state HTTP GET BURST or the value ‘0x000F’ representing the narrow transmission state HTTP GET STATIC, it is transitioned to a value representing ‘0x0207/0x020F’ representing a state DUP HTTP GET BURST/STATIC receiving a two-time duplicated ACK (state 1906). When the TCP-Flag 1111 receives the packet of ACK in the state, it returns to an original state. Also, when the delivery of the entire data of the VOD data is ended in a state where the communication state value F-STATE 1211 is transitioned to the value ‘0x0007’ representing the wideband transmission state HTTP GET BURST or the value ‘0x000F’ representing the narrowband transmission state HTTP GET STATIC, the communication F-STATE 1211 is transitioned to the value ‘0x0003’ representing the communication established state ESTAB (the transition is executed by the configuration for controlling TCP/IP & renewing VOD data area & transmitting VOD data 136) (state 1903). When the TCP-Flag 1111 receives the packet of FIN or FIN-ACK in a state where the communication state F-STATE 1211 is transitioned to the value ‘0x0001’ representing the connection requesting receive state SYN RCVD, the value ‘0x0003’ representing the communication established state ESTAB, the value ‘0x0007’ representing the wideband transmission state HTTP GET BURST, the value ‘0x000F’ representing the narrowband transmission state HTTP GET STATIC, or the value ‘0x0207/0x020F’ representing the state DUP HTTP GET BURST/STATIC receiving the two-time duplicated ACK, it is transitioned a value ‘0x0400’ representing the end requesting receive state CLOSE WAIT to reply the packet where the ACK is described in the TCP-Flag 1111 and the packet where the FIN-ACK is described in the TCP-Flag 1111 (state 1907). When the TCP-Flag 1111 receives the packet of ACK in a state where the communication state value F-STATE 1211 is transitioned to the value ‘0x0400’ representing the end requesting receive state CLOSE WAIT, it is transitioned to the value ‘0x0000’ representing the communication un-established state CLOSED (state 1901). Also, when the TCP-Flag 1111 receives the packet of RST or RST-ACK in a state where the communication state F-STATE 1211 receives the packet of FIN or FIN-ACK in a state where the communication state F-STATE 1211 is transitioned to the value ‘0x0001’ representing the connection requesting receive state SYN RCVD, the value ‘0x0003’ representing the communication established state ESTAB, the value ‘0x0007’ representing the wideband transmission state HTTP GET BURST, the value ‘0x000F’ representing the narrowband transmission state HTTP GET STATIC, the value ‘0x0207/0x020F’ representing the state DUP HTTP GET BURST/STATIC receiving the two-time duplicated ACK, or the value ‘0x0400’ representing the end requesting receive state CLOSE WAIT, it is transitioned to the value ‘0x0000’ representing the communication un-established state CLOSED (state 1901).

As shown in FIG. 19B, the communication state value B-STATE 1224 is also the value ‘0x0000’ representing the communication un-established state CLOSED to begin with (state 1908). When the communication state F-STATE 1211 is transitioned to the value ‘0x0007’ representing the wideband transmission state HTTP GET BURST, the communication state B-STATE 1224 is transitioned to the value ‘0x0001’ representing the connection requesting state SYN SENT requesting the connection with the VOD server 304 of the back end to transmit the packet where the SYN is described in the TCP-Flag 1111 to the server 304 (state 1909). Thereafter, when the PACK 1113 of the packet of SYN-ACK received by the TCP-Flag 1111 is equal to F-SEQ 1205+‘1’, the communication state value B-STATE 1224 is transitioned to a value “0x000B” representing a VOD data area renewing state DOWNLOAD (state 1910). When the renewal of the VOD data area is ended in a state where the communication state value B-STATE 1224 is transitioned to the value ‘0x000B’ representing the VOD data area renewing state DOWNLOAD, the communication state value B-STATE 1224 is transitioned to the a value ‘0x0800’ representing the end requesting transmission state FIN SENT to allow the TCT-Flag 1111 to transmit the packet of FIN-ACK to the VOD server 304 (the transition is executed by the configuration for controlling TCP/IP control and renewing VOD data area and transmitting VOD data 136) (state 1911). When the TCP-Flag 1111 receives the packet of FIN-ACK in a state where the communication state B-STATE 1224 is transitioned to the value ‘0x0800’ representing the end requesting transmission state FIN SENT, the communication state B-STATE 1224 is transitioned to the value ‘0x0000’ representing the communication un-establishment state CLOSED (state 1908). When the TCP-Flag 1111 receives the packet of FIN or FIN-ACK in a state where the communication state value B-STATE 1224 is transitioned to the value ‘0x0001’ representing the connection requesting state SYN SENT or the value ‘0x000B’ representing the VOD data area renewing state DOWNLOAD, it is transitioned to the value ‘0x0400’ representing the end requesting receive state CLOSD WAIT to reply the packet where the packet writing ACK in the TCP-Flag 111 and the FIN-ACK is described in the TCP-Flag 111 (state 1912). When the TCP-Flag 1111 receives the packet of ACK in a state where the communication state value B-STATE 1224 is transitioned to the value ‘0x0400’ representing the end requesting signal state CLOSE WAIT, it is transitioned to the value ‘0x0000’ representing the communication un-establishment state CLOSED (state 1908). Further, when the TCP-Flag 1111 receives the packet of RST in a state where the communication state value B-STATE 1224 is transitioned to the value ‘0x0001’ representing the connection requesting state SYN SENT, the value ‘0x000B’ representing the VOD data area renewing state DOWNLOAD, the value ‘0x0800’ representing the end requesting transmission state FIN SENT, or the value ‘0x0400’ representing the end requesting receive state CLOSE WAIT, it is transitioned to the value ‘0x0000’ representing the communication state un-established state CLOSED (state 1908).

The above-mentioned processes described with reference to FIG. 18 and FIGS. 19A and 19B are executed by the apparatus 200, such that the change in the communication state for controlling the transmission band and the change in the communication state using the receive packet can be realized.

When the communication state writing unit 120 receives the communication state 157 renewed by the communication state renewing unit 119 and the communication state 188 renewed by the wideband/narrowband transmission state 126, it writes the received communication states in the communication state table 105 (159).

The filter 192 filters the packet satisfying a specific condition based on the non-renewed communication state 156 read from the communication state reading unit 118, the renewed communication state 157 in the communication state renewing unit 119, and the packet 148 read from the packet buffer 190.

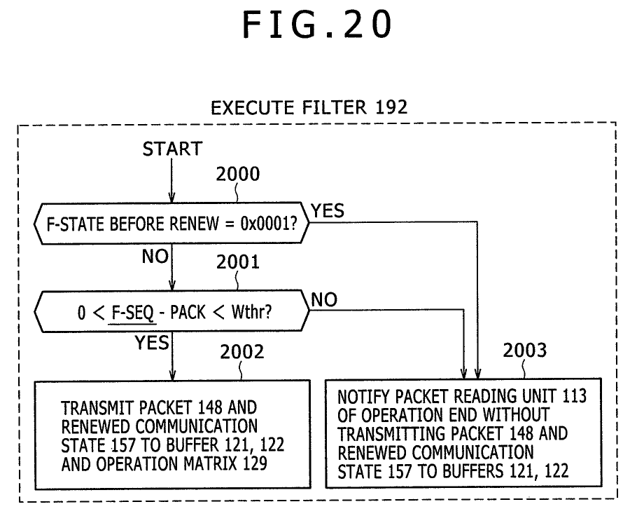

FIG. 20 is a flow chart of a process executed by the filter 192.

The filter 192 determines whether the value of the communication state value F-STATE 1211 of the non-renewed communication state 156 description read from the communication state reading unit 118 agrees with ‘0x0001’ (step 2000). When agreeing, the filter filters the packet 148 read from the packet buffer 190 and the renewed communication state 157 in the communication state renewing unit 119 and notifies the packet reading unit 113 of the operation end (194) (step 2003). When not agreeing, the filter 192 determines whether the difference of the F-SEQ 1205 of the non-renewed communication state 156 description read from the communication state reading unit 118 and the PACK 1111 of the packet 148 description is between the preset value Wthr and ‘0’ at step 2000 (step 2001). When not satisfying the condition of step 2001, the filter 192 filters the packet 148 read from the packet buffer 190 and the renewed communication state 157 of the communication state renewing unit 119 and notifies the packet reading unit 113 of the operation end (194) (step 2003). When satisfying the condition of step 2001, the filter 192 transmits the packet 148 read from the packet buffer 190 to the packet buffer 1200 (193) and transmits the renewed communication state 157 of the communication state renewing unit 119 to the configurations 134/135 for the interruption generation for general-purpose/autonomous reconfiguration within the operation matrix 129 and the communication state buffer 121 (158) (step 2002).

When the operation matrix 129 in the many-core processor 101 configuring the dynamic reconfiguration processing unit receives the communication state 158 from the filter 192, it reconfigures the internal logic circuit based on the values of the F-STATE 1211 or the B-STATE 1224 in the communication state 158 to perform the interruption generation for autonomous/general-purpose reconfiguration (the configuration for the interruption generation for general-purpose reconfiguration 134 and the configuration for the interruption generation for autonomous reconfiguration 135 are executed), the TCP/IP control, and the VOD data area renewal for transmission in the memory, the wideband/narrowband transmission of the VOD data (the configuration for controlling TCP/IP and renewing VOD data area and transmitting VOD data 136 is executed), the TCP/IP checksum computation and the packet transmission and the operation end notification (the configuration for computing TCP/IP checksum and transmitting packet and notifying operation end 137 is executed), etc.

The VOD data area renewing process for transmission in the memory renews a VOD data area for transmission previously prepared within external memory 103 (a data area for narrowband transmission 182, a record area for file name & playing point 183, a record area for read first address 184, a record area for renewed last address 185, a data area for wideband transmission 180, a pointer area 181 to a data for narrowband transmission). The renewing method includes two methods as described below, that is, a method 176 of renewing the VOD data area by allowing the operation matrix 129 to receive the VOD data from the VOD server 304 via the network and a method 178 of renewing the VOD data area by allowing the HDD data transfer function 173 to transmit the VOD data in the HDD 174. In the method of renewing the VOD data area by transmitting the VOD data previously accumulated in the HDD 174, the HDD data transfer function 173 executed by the general-purpose operator 130 executes the VOD data transmission from the HDD to the data area.

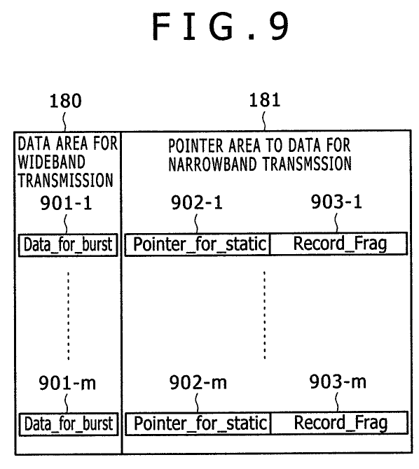

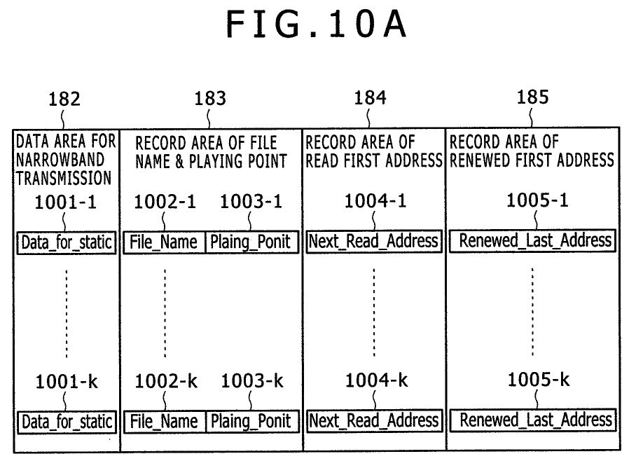

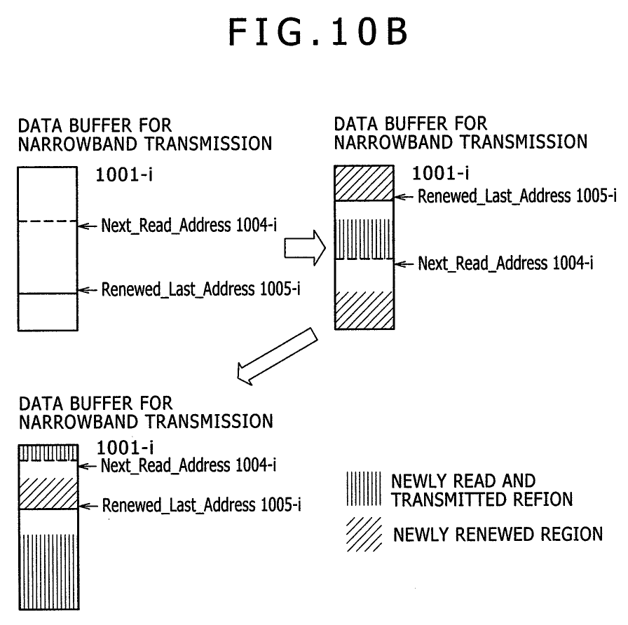

FIGS. 9 and 10A show one example of a format of the VOD data area for transmission. FIG. 9 shows the format of the VOD data area for wideband transmission 180 and FIG. 10A shows the format of the VOD data area for narrowband transmission.

The VOD data area for wideband transmission is configured of the data area for wideband transmission 180 and the pointer area 181 to the data for narrowband transmission. The data area for wideband transmission 180, which is an area temporarily buffering the entire data required for the wideband transmission of the VOD, is temporarily allocated to the extent required for the wideband transmission for each VOD delivery terminal and is configured of a data buffer Data_for_burst 901-i (i=1 to m) for wideband transmission whose allocation is released when the wideband transmission is not required. The pointer area 181 to the data for narrowband transmission is configured of a pointer Pointer_for_static 902-i (i=1 to m) to the data area for narrowband transmission used after the wideband transmission end and a Record_Flag 903-i (i=1 to m) recording a use state of the data buffer for wideband transmission Data_for_burst 901-i and has a one-to-one correspondence with the data buffer for wideband transmission Data_for_burst 901-i.

As shown in FIG. 10A, the VOD data area for narrowband transmission is configured of the data area for narrowband transmission 182, a record area for file name and playing point 183, the record area for read first address 184, and the record area for renewed last address 185. The data area for narrowband transmission 182, which is an area temporarily buffering a portion of the data required for the narrowband transmission of the VOD, is allocated for each VOD delivery terminal and is configured of a data buffer for narrowband transmission Data_for_static 1001-i (i=1 to k) whose allocation is released when the VOD delivery is ended. The record area for file name & playing point 183 is configured of a File_Name 1002-i (i=1 to k) whose delivery is requested by the VOD delivery terminal and the playing point Playing_Point 1003-i (i=1 to k) and has a one-to-one correspondence with the data buffer for narrowband transmission Data_for_static 1001-i. The record area for read first area 184 is configured of a reading start address value Next_Read_Address 1004-i (i=1 to k) of a data buffer for narrowband transmission Data_for_static 1001-i used when the VOD data is transmitted in a narrowband and has a one-to-one correspondence with a data buffer for narrowband transmission Data_for_static 1001-i. The record area for renewed last address 185 is configured of a last address Renewed_Last_Address 1005-i (i=1 to k) of the renewed data area in the data buffer for narrowband transmission Data_for_static 1001-i and has a one-to-one correspondence with the data buffer for narrowband transmission Data_for_static 1001-i.

The reading start address value Next_Read_Address 1004-i and the last address Renewed_Last_Address 1005-i of the renewed data area are transitioned while looping an address region range occupied by the data buffer for narrowband transmission Data_for_static 1001-i by repeating the renewal, read and transmission of the VOD data in the data buffer for narrowband transmission Data_for_static 1001-i (see FIG. 10B).

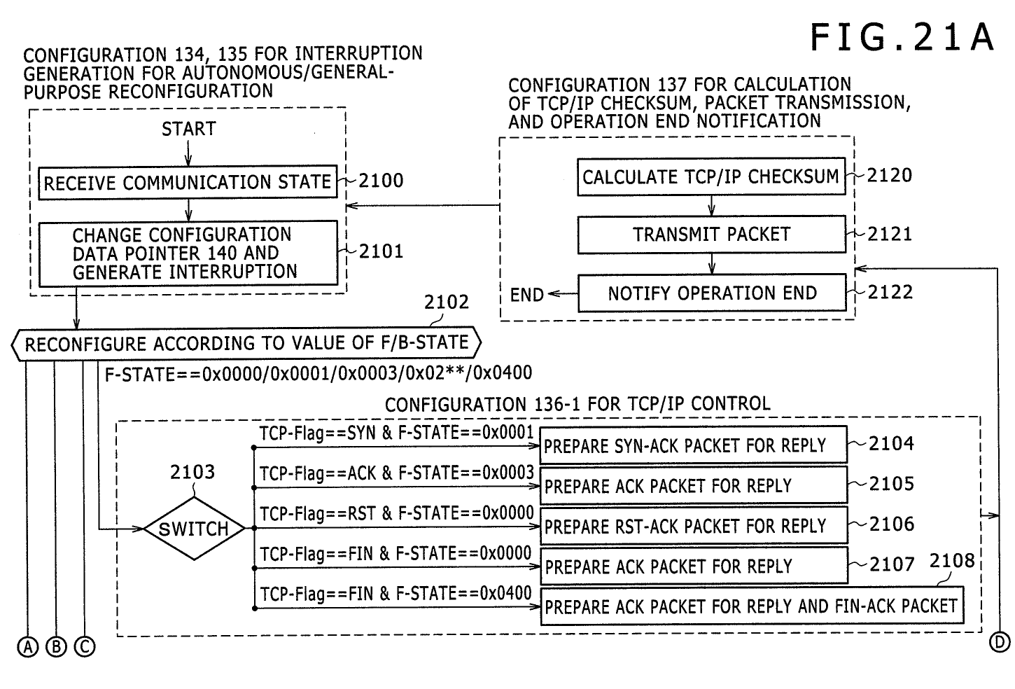

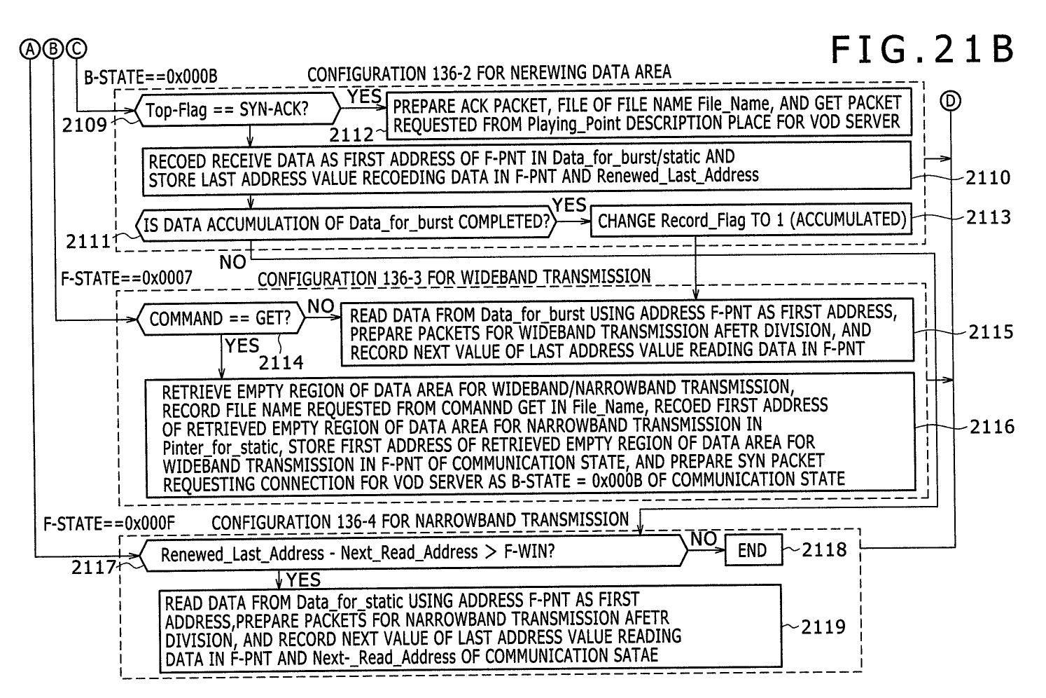

FIG. 21 shows a flow chart when the operation matrix 129 reconfigures the internal logic circuit based on the values of the F-STATE 1211 or the B-STATE 1224 in the communication state 158 to perform the interruption generation for autonomous/general-purpose reconfiguration (the configuration for the interruption generation for general-purpose reconfiguration 134 and the configuration for the interruption generation for autonomous reconfiguration 135 are executed), the TCP/IP control and the VOD data area renewal for transmission in the memory and the wideband/narrowband transmission of the VOD data (the configuration for controlling TCP/IP and renewing VOD data area and transmitting VOD data 136 is executed), and the TCP/IP checksum computation and the packet transmission and the operation end notification (the configuration for computing TCP/IP checksum and transmitting packet and notifying operation end 137 is executed) and renews the VOD data area for transmission in the memory from the VOD server 304 via the network.

When the configuration 135 for the interruption generation for autonomous reconfiguration receives the communication state 158 (step 2100), it generates the interruption for autonomous reconfiguration 166 to the operation matrix 129 itself (step 2101). At the same time, the operation matrix 129 reads and reconfigures the predefined configuration data according the communication state 158 from the configuration data caches 166 and 167 (step 2102).

When the configuration 134 for the interruption generation for general-purpose reconfiguration receives the communication state 158 (step 2100), it generates the interruption for general-purpose reconfiguration 169 to the general-purpose operator 130 and at the same time, defines the configuration date to be used subsequently based on the communication state 158 and writes the pointer value to the configuration data in the configuration data pointer 140 (168) (step 2101). When the general-purpose operator 130 receives the interruption 169, the OS 139 calls the logic circuit reconfiguration function 138. The logic circuit reconfiguration function 138 reads the configuration data from the configuration data area 141 based on the pointer 171 read from the configuration data pointer 140 (170) and transmits the read configuration data to the configuration data cache 131 (172) and then loads them to the operation matrix 129 (167), thereby reconfiguring the operation matrix 129 (step 2102).

When the receive packet is a packet transmitted from the front end terminal and the communication state values F-STATE 1211 are ‘0x0000’, ‘0x0001’, ‘0x0003’, ‘0x0207’, ‘0x020F’, and ‘0x0400’, the operation matrix is reconfigured into a configuration for controlling TCP/IP 136-1.

The configuration for controlling TCP/IP 136-1 changes the processing contents according to the TCP-Flag 1111 of the packet 162 description read from the packet buffer 122 and the communication state value F-STATE 1211 of the communication state 161 description read from the communication state buffer 121 (step 2103). When the TCP-Flag 1111 is SYN and the F-STATE 1211 is ‘0x0001’, the configuration for controlling TCP/IP 136-1 prepares the packet for reply using the TCP-Flag 1111 as the SYN-ACK (step 2104). When the TCP-Flag 1111 is ACK and the F-STATE 1211 is ‘0x0003’, the configuration for controlling TCP/IP 136-1 prepares the packet for reply using the TCP-Flag 1111 as the ACK (step 2105). When the TCP-Flag 1111 is RST and the F-STATE 1211 is ‘0x0000’, the configuration for controlling TCP/IP 136-1 prepares the packet for reply using the TCP-Flag 1111 as the RST-ACK (step 2106). When the TCP-Flag 1111 is FIN and the F-STATE 1211 is ‘0x0000’, the configuration for controlling TCP/IP 136-1 prepares the packet for reply using the TCP-Flag 1111 as the ACK (step 2107). When the TCP-Flag 1111 is FIN and the F-STATE 1211 is ‘0x0400’, the configuration for controlling TCP/IP 136-1 prepares the packet for reply using the TCP-Flag 1111 as the ACK and the packet for reply using the TCP-Flag 1111 as the FIN-ACK (step 2108).

When the receive packet is a packet transmitted from the front end terminal and the communication state value F-STATE 1211 is a value ‘0x0007’ representing the wideband transmission state HTTP GET BURST, it is reconfigured into a configuration for wideband transmission 136-3.

The configuration for wideband transmission 136-3 determines whether a command GET of HTTP is written in a Payload 1116 of the packet 162 description read from the packet buffer 122 (step 2114). When written, the configuration for wideband transmission 136-3 retrieves an empty region Data_for_burst 901 of the data area for wideband transmission 180 and an empty region Data_for_static 1001 of the data area for narrowband transmission 182. Thereafter, the configuration for wideband transmission 136-3 writes the file name requested by the command GET in a File_Name 1002 corresponding to the retrieved empty region 1101 of the data area for wideband transmission 180. Also, the configuration for wideband transmission 136-3 writes the first address of the retrieved empty region Data_for_static 1001 of the data area for narrowband transmission 180 in a Pointer_for_static 902 corresponding to the retrieved empty region 901 of the data area for wideband transmission 180. In addition, the configuration for wideband transmission 136-3 stores the first address of the retrieved empty region Data_for_burst 901 of the data area for wideband transmission 180 in the pointer F-PNT 1210 of the communication state and makes the internal communication state value B-STATE 1224 the value ‘0x000B’ representing the VOD data area renewing state DOWNLOAD and then prepares the packet requesting the connection to the VOD server 304 using the TCP-Flag 1111 as the SYN (step 2116). At step 2114, when the command GET is not written, the configuration for wideband transmission 136-3 reads the VOD data from the region Data_for_burst 901 of the data area for wideband transmission 180 using the address of the pointer value F-PNT 1210 description in the communication state 161 as the first address and divides the read data and then prepares the plural packets for wideband transmission. The configuration for wideband transmission 136-3 writes the address value subsequent to the last address value reading the data in the address value of the pointer value F-PNT 1210 description (step 2115).

The receive packet is a packet transmitted from the back end terminal and the communication state value B-STATE 1224 is the value ‘0x000B’ representing the VOD data area renewing state DOWNLOAD, it is reconfigured into a configuration for renewing the VOD data area 136-2.

The configuration for renewing the VOD data area 136-2 determines whether the TCP-Flag 1111 of the packet 162 description read from the packet buffer 122 is SYN-ACK (step 2109). When the TCP-Flag 1111 is SYN-ACK, the configuration for renewing the VOD data area 136-2 prepares the packet using the TCP-Flag 1111 as ACK to the VOD server 304. Also, the configuration for renewing the VOD data area 136-2 reads the region Data_for_burst 901 of the data area for wideband transmission 180 and the corresponding the Pointer_for_static 902 based on the pointer value F-PNT 1210 of the communication state description. In addition, the configuration for renewing the VOD data area 136-2 reads the region Data_for_static 1001 of the data area for narrowband transmission 182 designated by the Pointer_for_static 902 and the corresponding File_Name 1002 and Playing_Point 1003 and prepares the file data of the file name File_Name 1002 and the packet requested from the point described in the Playing_Point 1003 to the VOD server 304 using the command GET of HTTP (step 2112). At step 2109, when the TCP-Flag 1111 is not SYN-ACK, the configuration for renewing the VOD data area 136-2 accumulates the VOD data of the Payload 1116 description of the receive packet and the pointer value F-PNT 1210 of the communication state description as the first address in the data region for the wideband transmission Data_for_burst 901 or the data region for narrowband transmission Data_for_static 1001. Also, when there is no empty region in the data region for the wideband transmission Data_for_burst 901, the configuration for renewing the VOD data area 136-2 accumulates the address value of Pointer_for_static 902 description as the first address and the remaining data in the data region for narrowband transmission Data_for_static 1001. Also, the configuration for renewing the VOD data area 136-2 changes the pointer value F-PNT 1210 to the last address value accumulated with the data. Finally, when the address value accumulated with the data is in the data region for narrowband transmission Data_for_static 1001, the configuration for renewing the VOD data area 136-2 records the last address value accumulated with the data in the Renewed_Last_Address 1005 (step 2110). Thereafter, the configuration for renewing the VOD data area 136-2 determines whether the data region for wideband transmission Data_for_burst 901 is embedded in the VOD data (step 2111). When embedded, the configuration for renewing the VOD data area 136-2 changes the value of Record_Flag 903 to ‘1’ (represents the accumulated state) (step 2113) and then performs the above-mentioned step 2115. When not embedded, the configuration for renewing the VOD data area 136-2 performs the following step 2117.

The receive packet is a packet transmitted from the front end terminal and the communication state value F-STATE 1211 is the value ‘0x000F’ representing the narrowband transmission state HTTP GET STATIC, it is reconfigured into a configuration for narrowband transmission 136-4.

The configuration for narrowband transmission 136-4 reads the values of the Renewed_Last_Address 1005 and the Next_Read_Address 1004 corresponding to the data region for narrowband transmission Data_for_static 1001 based on the value of the pointer value F-PNT 1210 of the communication state to determine whether the difference of the Renewed_Last_Address 1005 and the Next_Read_Address 1004 is larger than the congestion window size F-WIN 1207 (step 2117). When not large, the configuration for narrowband transmission 136-4 is ended without performing any task (step 2118). When large, the configuration for narrowband transmission 136-4 reads the VOD data from the data region for narrowband transmission Data_for_static 1001 using the address value of the pointer value F-PNT 1210 description of the communication state as the first address and divides the read data in plural and then prepares the packets for the plural narrowband transmissions. Also, the last address value reading the data records in the F-PNT 1210 and the Next_Read_Address 1004 (step 2119).

When the processes are ended in the configuration for controlling TCP/IP 136-1, the configuration for renewing the VOD data area 136-2, the configuration for wideband transmission 136-3, and the configuration for narrowband transmission 136-4, it is reconfigured into the configuration for computing TCP/IP checksum & transmitting packet & notifying operation end 137.

The configuration for computing TCP/IP checksum & transmitting packet & notifying operation end 137 computes the TCP/IP checksum with respect to the packet generated according to the configurations 136-1 to 4 (step 2120) and transmits the packet (step 2121). When the transmission of the entire packet is ended, the configuration for computing TCP/IP checksum & transmitting packet & notifying operation end 137 outputs the operation end notification 164 to the transmission byte counter 128 and the packet reading unit 113 (step 2122).

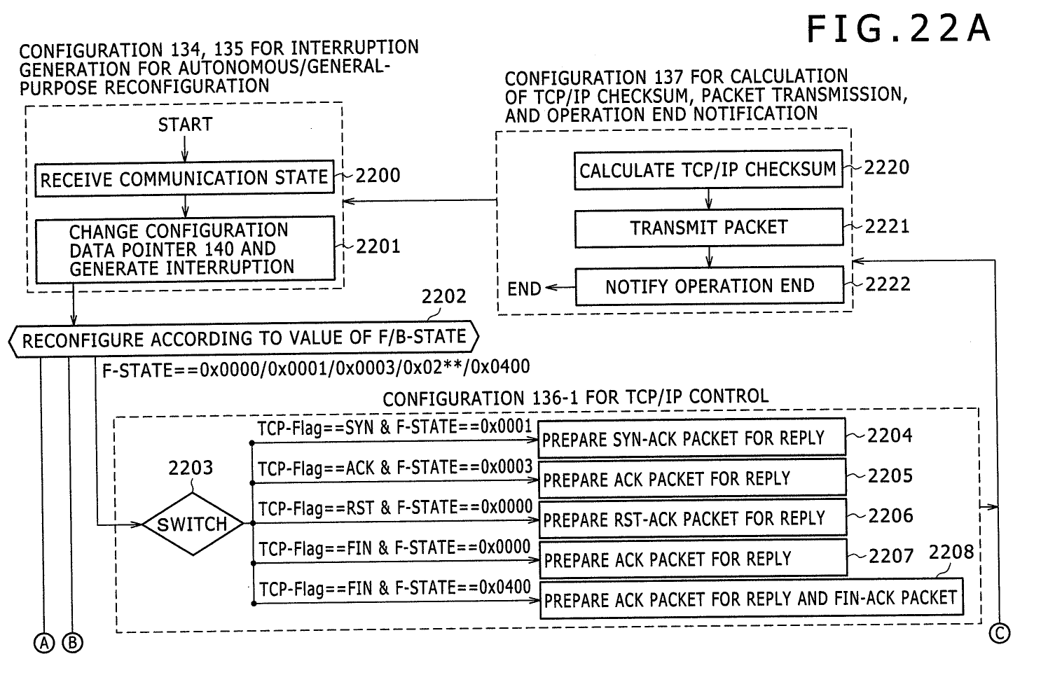

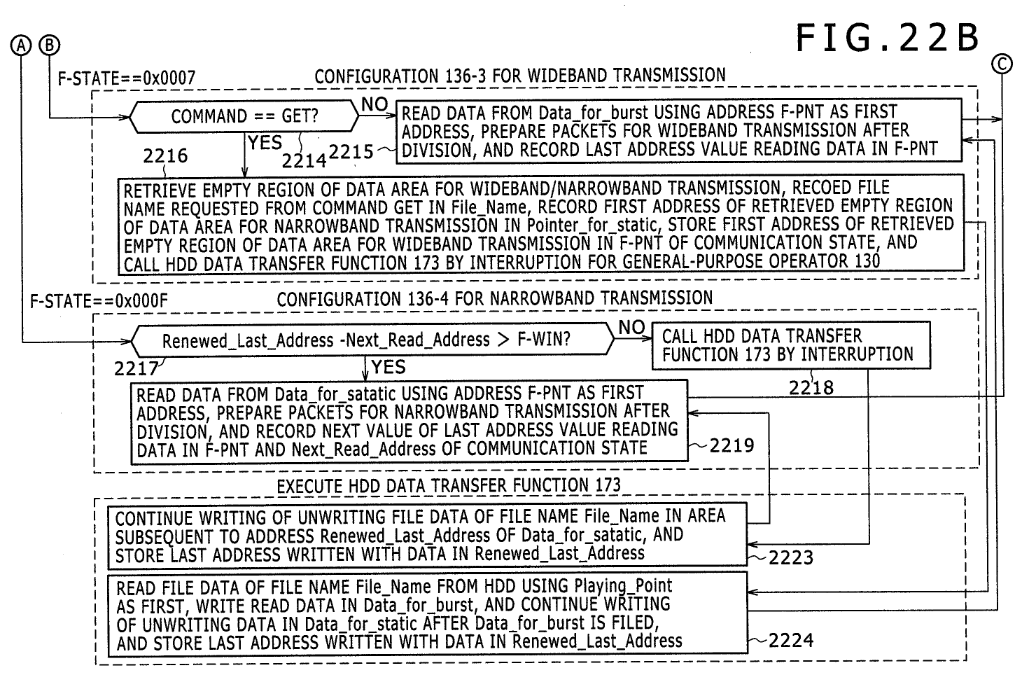

FIG. 22 shows a flow chart when the operation matrix 129 reconfigures the internal logic circuit based on the values of the F-STATE 1211 or the B-STATE 1224 in the communication state 158 to perform the interruption generation for autonomous/general-purpose reconfiguration (the configuration for the interruption generation for general-purpose reconfiguration 134 and the configuration for the interruption generation for autonomous reconfiguration 135 are executed), the TCP/IP control and the wideband/narrowband transmission of the VOD data (the configuration for controlling TCP/IP and transmitting VOD data 136 is executed), and the TCP/IP checksum computation and the packet transmission and the operation end notification (the configuration for computing TCP/IP checksum and transmitting packet and notifying operation end 137 is executed), such that the HDD data transfer function 173 renews the VOD data area for transmission in the memory from HDD 174 via the PCI I/F 179.

When the configuration for the interruption generation for autonomous reconfiguration 135 receives the communication state 158 (step 2200), it generates the interruption for autonomous reconfiguration 166 to the operation matrix 129 itself (step 2201). At the same time, the operation matrix 129 reads and reconfigures the predefined configuration data according the communication state 158 from the configuration data caches 166 and 167 (step 2202).

When the configuration for the interruption generation for general-purpose reconfiguration 134 receives the communication state 158 (step 2200), it generates the interruption for general-purpose reconfiguration 169 to the general-purpose operator 130 and at the same time, defines the configuration date to be used subsequently and writes the pointer value to the configuration data in the configuration data pointer 140 (step 2201) based on the communication state 158 (168). When the general-purpose operator 130 receives the interruption 169, the OS 139 calls the logic circuit reconfiguration function 138. The logic circuit reconfiguration function 138 reads the configuration data from the configuration data area 141 based on the pointer 171 read from the configuration data pointer 140 (170) and transmits the read configuration data to the configuration data cache 131 (172) and then loads them to the operation matrix 129 (167), thereby reconfiguring the operation matrix 129 (step 2202).

When the receive packet is a packet transmitted from the front end terminal and the F-STATE 1211 are ‘0x0000’, ‘0x0001’, ‘0x0003’, ‘0x0207’, ‘0x020F’, and ‘0x0400’, it is reconfigured into a configuration for controlling TCP/IP 136-1.

The configuration for controlling TCP/IP 136-1 changes the processing contents according to the value of the TCP-Flag 1111 of the packet 162 description read from the packet buffer 122 and the F-STATE 1211 of the communication state 161 description read from the communication state buffer 121 (step 2203). When the TCP-Flag 1111 is SYN and the F-STATE 1211 is ‘0x0001’, the configuration for controlling TCP/IP 136-1 prepares the packet for replying by using the TCP-Flag 1111 as the SYN-ACK (step 2204). When the TCP-Flag 1111 is ACK and the F-STATE 1211 is ‘0x0003’, the configuration for controlling TCP/IP 136-1 prepares the packet for reply using the TCP-Flag 1111 as the ACK (step 2205). When the TCP-Flag 1111 is RST and the F-STATE 1211 is ‘0x0000’, the configuration for controlling TCP/IP 136-1 prepares the packet for replying by using the TCP-Flag 1111 as the RST-ACK (step 2206). When the TCP-Flag 1111 is FIN and the F-STATE 1211 is ‘0x0000’, the configuration for controlling TCP/IP 136-1 prepares the packet for replying by using the TCP-Flag 1111 as the ACK (step 2207). When the TCP-Flag 1111 is FIN and the F-STATE 1211 is ‘0x0400’, the configuration for controlling TCP/IP 136-1 prepares the packet for replying by using the TCP-Flag 1111 as the ACK and the packet for replying by using the TCP-Flag 1111 as the FIN-ACK (step 2208).

When the receive packet is a packet transmitted from the front end terminal and the F-STATE 1211 is a value ‘0x0007’ representing the wideband transmission state HTTP GET BURST, it is reconfigured into a configuration for wideband transmission 136-3.

The configuration for wideband transmission 136-3 determines whether a command GET of HTTP is written in a Payload 1116 of the packet 162 description read from the packet buffer 122 (step 2214). When the command GET is not written, the configuration for wideband transmission 136-3 reads the VOD data from the region Data_for_burst 901 of the data area for wideband transmission 180 using the address of the F-PNT 1210 description in the communication state 161 as the first address and divides the read data in plural and then prepares the plural packets for wideband transmission. Also, the configuration for wideband transmission 136-3 writes the address value subsequent to the last address value reading the data in the address value of the F-PNT 1210 description (step 2215). At step 2214, when the command GET is written, the configuration for wideband transmission 136-3 retrieves an empty region Data_for_burst 901 of the data area for wideband transmission 180 and an empty region Data_for_static 1001 of the data area for narrowband transmission 182. Thereafter, the configuration for wideband transmission 136-3 writes the file name of the file requested by the command GET in the File Name 1002 corresponding to the retrieved empty region 1101 of the data area for narrowband transmission 182. Also, the configuration for wideband transmission 136-3 writes the first address of the retrieved empty region Data_for_static 1001 of the data area for narrowband transmission 182 in the Pointer_for_static 902 corresponding to the retrieved empty region 901 of the data area for wideband transmission 180. In addition, the configuration for wideband transmission 136-3 stores the first address of the retrieved empty region Data_for_burst 901 of the data area for wideband transmission 180 in the F-PNT 1210 of the communication state and then generates the interruption for general-purpose operation 130 (177) and calls the HDD data transfer function 173 (step 2216).

The called HDD data transfer function 173 reads the file data of the file name File_Name 1002 from the HDD 174 using the Playing_Pointer 1003 designation point as the first address (175) and writes the read data in the retrieved empty region Data_for_burst 901 of the data area for wideband transmission 180 (178). Also, after the retrieved empty region Data_for_burst 901 of the data area for wideband transmission 180 is filled, the subsequent data is written in the retrieved empty region Data_for_static 1001 of the data area for narrowband transmission 182 and the last address written with data is stored in Renewed_Last_Address 1005 (step 2224) corresponding to the retrieved empty region Data_for_static 1001.

When the process of step 2224 in the HDD data transfer function 173 is ended, the process of step 2215 in the configuration for wideband transmission 136-3 is performed.

The receive packet is a packet transmitted from the front end terminal and the F-STATE 1211 is the value ‘0x000F’ representing the narrowband transmission state HTTP GET STATIC, it is reconfigured into a configuration for narrowband transmission 136-4.

The configuration for narrowband transmission 136-4 reads the values of Renewed_Last_Address 1005 and Next_Read_Address 1004 corresponding to the data region for narrowband transmission Data_for_static 1001 based on the address value of the F-PNT 1210 description of the communication state to determine whether the difference of the Renewed_Last_Address 1005 and the Next_Read_Address 1004 is larger than the congestion window size F-WIN 1207 (step 2217). When large, the configuration for narrowband transmission 136-4 reads the VOD data from the data region for narrowband transmission Data_for_static 1001 using the address value of the F-PNT 1210 description of the communication state as the first address and divides the read data in plural and then prepares the packets for the plural narrowband transmissions. Also, the configuration for narrowband transmission 136-4 writes the address value subsequent to the last address value reading the data in the F-PNT 1210 and the Next_Read_Address 1004 (step 2219). At step 2217, when not large, the configuration for narrowband transmission 136-4 generates the interruption for general-purpose operation 130 (177) and calls the HDD data transfer function 173 (step 2218).

The called HDD data transfer function 173 writes the continuation of the non-written file data of the file name File_Name 1002 in the region Data_for_static 1001 in the data area for narrowband transmission 182 using the one designation address of the Renewed_Last_Address 1005 as the first address from the HDD 174 and stores the last address written with the data in the Renewed_Last_Address 1005 corresponding to the data region for narrowband transmission Data_for_static 1001 (step 2223).

When the process of step 2223 in the HDD data transfer function 173 is ended, the process of step 2219 in the configuration for narrowband transmission 136-4 is performed.

When the processes are ended in the configuration for controlling TCP/IP 136-1, the configuration for wideband transmission 136-3, and the configuration for narrowband transmission 136-4, it is reconfigured into the configuration for computing TCP/IP checksum and transmitting packet and notifying operation end 137.

The configuration for computing TCP/IP checksum transmitting packet and notifying operation end 137 computes the TCP/IP checksum of the packet generated according to the configurations 136-1, 136-3, and 136-4 (step 2220) and transmits the packet (step 2221). When the transmission of the entire packet is ended, the configuration for computing TCP/IP checksum and transmitting packet and notifying operation end 137 outputs the operation end notification 164 to the transmission byte counter 128 and the packet reading unit 113 (step 2222).

The HDD data transfer function 173 is called according to the interruption of the operation matrix 129 to perform the renewal of the VOD data area as well as is periodically called by the OS 139 to perform the renewal of the VOD data area as described above.

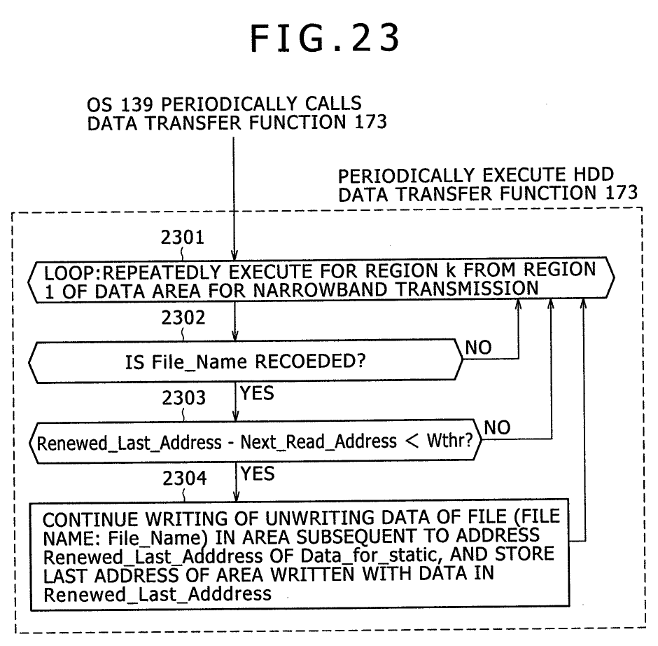

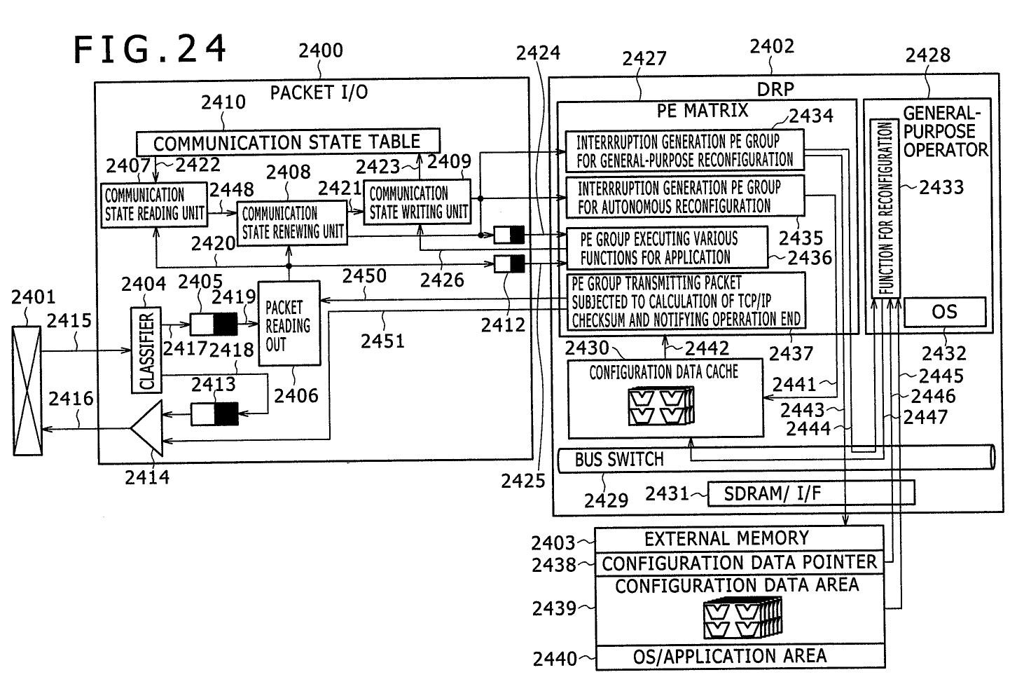

FIG. 23 shows a flow chart of a process where the HDD data transfer function 173 is periodically called by the OS 139 to perform the renewal of the VOD data area.

When the HDD data transfer function 173 of the general-purpose operator 130 receives a periodic call by the OS 139, it repetitively executes the renewal of the VOD data for each of the k regions Data_for_static 1001-i (i=1 to k) within the data area for narrowband transmission 182 (step 2301). First, it determines whether the file name is stored in File_Name 1002 corresponding to the Data_for_static 1001 (step 2302). When the file name is stored, the HDD data transfer function 173 determines whether the difference of the Renewed_Last_Address 100 and Next_Read_Address 1004 corresponding to the Data_for_static 1001 is smaller than the preset threshold value Wthr (step 2303). When the difference is smaller than the preset threshold value Wthr, the HDD data transfer function 173 writes the continuation of the non-written file data of the file name File_Name 1002 in the region Data_for_static 1001 in the data area for narrowband transmission 182 using the one designation address of the Renewed_Last_Address 1005 as the first address and stores the last address written with the data in the Renewed_Last_Address 1005 (step 2304) corresponding to the data region for narrowband transmission Data_for_static 1001 and. Thereafter, it executes the renewal of the VOD data for the subsequent region Data_for_static 1001-i. When the file name is not stored at step 2302 or when the difference is not smaller than the preset threshold Wthr at step 2303, the HDD data transfer function 173 returns to step 2301 to perform the renewal of the VOD data for the subsequent region Data_for_static 1001-i.

As described above, the apparatus 200 performs the processes described with reference to FIGS. 21 to 23, such that the VOD data for delivery can be read beforehand from the terminal accumulated with the VOD file or the disk unit accumulated with the VOD file and can buffered in the VOD data accumulation area for transmission.

The concentrator 114 of the packet I/O 100 of FIG. 1 concentrates the packet 165 received from the configuration for computing TCP/IP checksum & transmitting packet & notifying operation end 137 and the packets read from the packet buffer 112 and output concentrated packet (144).

When the packet reading unit 113 receives the operation end notification 194 from the filter 192 or the operation end notification 164 form the operation matrix 129, it reads back the packet accumulated in the buffer 111 (147) and transmits the read packet to the packet type determining unit 109, the terminal access determining unit 108, and the packet buffer 190 (191).

### Second Embodiment

Although the first embodiment describes the method of changing the communication state from the wideband transmission state to the narrowband transmission state based on the transmission data, when the Proto 1106 of the packet is the TCP and RCTP (RTP Control Protocol), it can change the communication state from the wideband transmission state to the narrowband transmission state based on the receive packet.

A second embodiment performs the integration of the byte integrated amount F-BYT 1212 or the change in the F-STATE 1211 from the wideband transmission state to the narrowband transmission state in the communication state renewing unit 119.

When the Proto 1106 of the receive packet is TCP, the communication state changing unit 119 adds the difference of the PACK 1113 of the receive packet description and the F-SEQ 1205 of the communication state to the byte integrated amount F-BYT 1212. Also, when the state value F-STATE 1211 is the value ‘0x0007’ representing the wideband transmission state and the sum of the added byte integrated amount F-BYT 1212 and the arrival unconfirmed transmission amount F-FLT 1208 exceeds the preset threshold value Bthr, the communication state changing unit 119 changes the state value F-STATE 1211 to the value ‘0x000f’ representing the narrowband transmission state.

When the Proto 1106 of the receive packet is RTCP, the communication state changing unit 119 changes the byte integrated amount F-BYT 1212 based on the contents of the OtherHeader 1114 description of the receive packet description and when the changed byte integrated amount F-BYT 1212 exceeds the preset threshold value Bthr, the communication state changing unit 119 changes the state value F-STATE 1211 to the value ‘0x000f’ representing the narrowband transmission state.

As described above, even when the protocol is TCP/RTCP, the communication state can be changed from the wideband transmission state to the narrowband transmission state based on the receive packet. As can be appreciated from the foregoing description, it is to be noted that the method of changing the state of the byte integrated amount F-BYT 1212 according to the present embodiment is different for each kind of used protocol.

Although the foregoing description shows the VOD server as the server and the VOD data as the data output by the server, the present invention is not limited to the VOD server and the VOD data. As a result, the present invention can be applied to other data, such as the query transaction of the database, the defense of abnormal communication, etc., transmitted between the terminals or between the terminal and the server.

What is claimed is:

1. An information processing apparatus performing a process on a packet transmitted and received via a network comprising:
a communication state table that stores a communication state between terminals transmitting and receiving the packet;
a first communication state renewing unit that changes the communication state according to a combination of internal information on the received packet and a communication state read from the communication state table based on the internal information on the packet;
a dynamic reconfiguration unit that includes an operation matrix having a group of operators whose functions and wirings are different and plural configuration information accumulation buffers storing configuration information on the operation matrix to receive the packet and the changed communication state, obtains the configuration information from the configuration information accumulation buffer based on the changed communication state, and reconfigures the functions and wirings of the group of operators in the operation matrix based on the obtained configuration information; and
a second communication state renewing unit that performs the change in the communication state based on data output from the dynamic reconfiguration processing unit.

2. The information processing apparatus according to claim 1, wherein the second communication state renewing unit includes:
in order to change processing contents based on a transmission data amount that is the data output from the dynamic reconfiguration processing unit,
a transmission amount counter that counts a transmitted data amount after communication start for each communication state;
a transmission amount determining unit that compares the transmitted data amount with a preset threshold value; and
a transmission state changing unit that changes the communication state when it is determined that the transmitted data amount is larger than the threshold value in the transmission amount determining unit,
the dynamic reconfiguration processing unit reconfiguring the functions and wirings of the group of operators in the operation matrix based on the communication state changed according to the transmitted data amount.

3. The information processing apparatus according to claim 2, wherein the dynamic reconfiguration processing unit reconfigures the functions and wirings of the group of the operators in the operation matrix so that it becomes a logic circuit that performs a wideband transmission process on the data when it is determined that the transmitted data amount is smaller than the threshold value in the second communication state renewing unit and a logic circuit that performs a narrowband transmission process on the data when it is determined that the transmitted data amount is larger than the threshold value in the second communication state renewing unit.

4. The information processing apparatus according to claim 1, wherein the second communication state changing unit includes:
a transmission time determining unit that compares a transmission time of transmission data being the output data with the preset threshold value for each communication state; and
a transmission state changing unit that changes the communication state when it is determined that the transmission time is larger than the threshold value in the transmission time determining unit,
the dynamic reconfiguration processing unit reconfiguring the functions and wirings of the group of operators in the operation matrix based on the communication state changed according to the transmission time.

5. The information processing apparatus according to claim 4, wherein the dynamic reconfiguration processing unit reconfigures the functions and wirings of the group of operators in the operation matrix so that it becomes a logic circuit that performs a wideband transmission process on the data when the transmission time is smaller than the threshold value in the second communication state renewing unit and a logic circuit that performs a narrowband transmission process on the data when the transmission time is larger than the threshold value in the second communication state renewing unit.

6. The information processing apparatus according to claim 1, wherein the communication state includes a transmission capability amount representing a data amount that can be transmitted without confirming receipt of a transmission destination terminal, the information processing apparatus further comprising:
a transmission or non-transmission/band setting table that records permission/prohibition and a transmission capability band of the data transmission for each terminal;
a terminal access determining unit that reads the permission/prohibition and the transmission capability band of the data transmission for each terminal from the transmission or non-transmission/band setting table based on the internal information on the received packet;
a transmission band estimating unit that estimates an average transmission band to the transmission destination terminal and an arrival unconfirmed transmission amount representing the transmitted data amount without confirming receipt of the transmission destination terminal based on the internal information on the received packet and the communication state read from the communication state table; and
a transmission capability amount setting unit that sets the data transmission capability amount for each destination terminal based on the communication state read from the communication state table, the average transmission band and the arrival of unconfirmed transmission amount estimated by the transmission band estimation unit and the transmission capability band read by the access determining unit.

7. The information processing apparatus according to claim 1, further comprising a storage unit that includes a data area for transmission accumulating a portion of data of a file for transmission,
the dynamic reconfiguration processing unit reconfiguring the functions and wirings of the group of operators in the operation matrix so that it becomes a logic circuit that starts communication with the terminal accumulating the file for transmission when a portion of the data of the file for transmission is not accumulated in the storage unit and when the packet is received from the terminal after communication starts, performs a process of accumulating data included in the received packet in the data area for transmission of the storage unit.

8. The information processing apparatus according to claim 1, further comprising:
a disk unit accumulating the file for transmission; and
a storage unit that includes a data area for transmission accumulating a portion of data of the file for transmission,
the dynamic reconfiguration processing unit further including a general-purpose processor that performs a disk data transfer function transmitting a portion of the file for transmission accumulated in the disk unit from the disk unit to the data area for transmission of the storage unit when a portion of the data of the file for transmission is not accumulated in the storage unit.

9. An information processing apparatus performing a process on a packet transmitted and received via a network comprising:
a packet type determining unit that determines a packet type based on internal information on the received packet;
a communication state table that stores a communication state between terminals transmitting and receiving the packet;
first and second operation matrixes that include a group of operators whose functions and wirings are different; and
first and second dynamic reconfiguration processing units that include first and second configuration information accumulation buffers, respectively, that store a plurality of pieces of configuration information on the operation matrixes,
the first dynamic reconfiguration processing unit obtaining the configuration information from the first configuration information accumulation buffer based on the determination result of the packet type determining unit and reconfiguring the functions and wirings of the group of operators in the first operation matrix based on the obtained configuration information and realizing, due to the group of operators, the communication state renewing unit that performs the change in the communication state according to a combination of the internal information on the received packet and the communication state read from the communication state table based on the internal information on the packet, and
the second dynamic reconfiguration unit obtaining the configuration information from the second configuration information accumulation buffer based on the communication state renewed by the communication state renewing unit and reconfiguring the functions and wirings of the group of operators in the second operation matrix based on the obtained configuration information.

10. The information processing apparatus according to claim 9, wherein the first dynamic reconfiguration processing unit further includes a general-purpose operation processor,
the first operation matrix realizing an interruption generating unit for reconfiguring the group of operators that generates an interruption for reconfiguring the general-purpose processor or the first operation matrix based on the determining result of the packet type determining unit and reconfiguring the functions and wirings of the group of operators in the first operation matrix based on the interruption generated from the interruption generating unit for reconfiguration.

11. The information processing apparatus according to claim 9, further comprising:
a transmission or non-transmission/band setting table that records a permission/prohibition and a transmission capability band of the data transmission for each terminal; and
a terminal access determining unit that reads the permission/prohibition and the transmission capability band of the data transmission for each terminal from the transmission or non-transmission/band setting table based on internal information of the received packet,
the first dynamic reconfiguration processing unit obtaining the configuration information from the first configuration information accumulation buffer based on the determination result of the packet type determining unit and permission/prohibition and the transmission capability band for each terminal read by the terminal access determining unit and reconfiguring the functions and wirings of the group of operators in the first operation matrix based on the obtained configuration information.

12. The information processing apparatus according to claim 9, wherein the communication state includes a transmission capability amount representing a data amount that can be transmitted without confirming receipt of a transmission destination terminal, the information processing apparatus further comprising:
a transmission or non-transmission/band setting table that records permission/prohibition and a transmission capability band of the data transmission for each terminal; and
a terminal access determining unit that reads the permission/prohibition and the transmission capability band of the data transmission for each terminal from the transmission or non-transmission/band setting table based on the internal information on the received packet,
the first dynamic reconfiguration processing unit realizing, in the group of operators, a transmission band estimating unit that estimates an average transmission band of the transmission destination terminal and an arrival of an unconfirmed transmission amount representing the transmitted data amount without confirming the receipt of the transmission destination terminal based on the internal information on the received packet and the communication state read from the communication state table, and a transmission capability amount setting unit that sets the data transmission capability amount for each destination terminal based on the communication state read from the communication state table, the average transmission band and the arrival unconfirmed transmission amount estimated by the transmission band estimation unit, and the transmission capability band read by the access determining unit.

13. The information processing apparatus according to claim 9, further comprising a storage unit that includes a data area for transmission accumulating a portion of data of a file for transmission,
the second dynamic reconfiguration processing unit reconfiguring the functions and wirings of the group of operators in the operation matrix so that it becomes a logic circuit that starts communication with the terminal accumulating the file for transmission when a portion of the data of the file for transmission is not accumulated in the storage unit and when the packet is received from the terminal after the communication start, performs a process of accumulating data included in the received packet in the data area for transmission of the storage unit.

14. The information processing apparatus according to claim 9, further comprising:
a disk unit accumulating the file for transmission; and
a storage unit that includes a data area for transmission accumulating a portion of data of the file for transmission,
the second dynamic reconfiguration processing unit further including a general-purpose processor that performs a disk data transfer function transmitting a portion of the file for transmission accumulated in the disk unit from the disk unit to the data area for transmission of the storage unit when a portion of the data of the file for transmission is not accumulated in the storage unit.

15. An information processing system including a server, a terminal requesting data from the server via a network, an information processing apparatus that receives a packet transmitted between the server and the terminal and performs a process according to a communication state between the server and the terminal transmitting and receiving the packet, the information processing apparatus comprising:
a communication state table that stores a communication state between the terminals transmitting and receiving the packet;
a first communication state renewing unit that changes the communication state according to a combination of internal information on the received packet and the communication state read from the communication state table based on the internal information on the packet;
a dynamic reconfiguration unit that includes an operation matrix having a group of operators whose functions and wirings are different and a plurality of pieces of configuration information accumulation buffers storing configuration information on the operation matrix to receive the packet and the changed communication state, obtain the configuration information from the configuration information accumulation buffer based on the changed communication state, and reconfigure the functions and wirings of the group of operators in the operation matrix based on the obtained configuration information; and
a second communication state renewing unit that performs the change in the communication state based on the data output from the dynamic reconfiguration processing unit.

16. The information processing system according to claim 15, wherein the second communication renewing unit in the information processing apparatus includes:
in order to change processing contents based on a transmission data amount from the dynamic reconfiguration processing unit,
a transmission amount counter that counts a transmitted data amount after communication start for each communication state;
a transmission amount determining unit that compares the transmitted data amount with a preset threshold value; and
a transmission state changing unit that changes the communication state when it is determined that the transmitted data amount is larger than the threshold value in the transmission amount determining unit,
the dynamic reconfiguration processing unit in the information processing apparatus reconfiguring the functions and wirings of the group of operators in the operation matrix based on the communication state changed according to the transmitted data amount.

17. The information processing system according to claim 16, wherein the dynamic reconfiguration processing unit in the information processing apparatus reconfigures the functions and wirings of the group of operators in the operation matrix so that it becomes a logic circuit that performs a wideband transmission process on the data when it is determined that the transmitted data amount is smaller than the threshold value in the second communication state renewing unit and a logic circuit that performs a narrowband transmission process on the data when it is determined that the transmitted data amount is larger than the threshold value in the second communication state renewing unit.

18. The information processing system according to claim 15, wherein the second communication state changing unit in the information processing apparatus includes:
a transmission time determining unit that compares a transmission time of transmission data being the output data with the preset threshold value for each communication state; and
a transmission state changing unit that changes the communication state when it is determined that the transmission time is larger than the threshold value in the transmission time determining unit,
the dynamic reconfiguration processing unit in the information processing apparatus reconfiguring the functions and wirings of the group of operators in the operation matrix based on the communication state changed according to the transmission time.

19. The information processing system according to claim 18, wherein the dynamic reconfiguration processing unit in the information processing apparatus reconfigures the functions and wirings of the group of operators in the operation matrix so that it becomes a logic circuit that performs a wideband transmission process on the data when the transmission time is smaller than the threshold value in the second communication state renewing unit and a logic circuit that performs a narrowband transmission process on the data when the transmission time is larger than the threshold value in the second communication state renewing unit.

20. The information processing system according to claim 15, wherein the server is a VOD server and the output data includes VOD data.
